(19) United States
(12) Patent Application Publication
(10) Pub. No.: US 2025/0144940 A1
(43) Pub. Date: May 8, 2025

(54) TANK HAVING OUTLET POSITIONED IN PROTRUDING CHAMBER BELOW LIQUID STORAGE CHAMBER, AND LIQUID-CONSUMING DEVICE INCLUDING THE SAME

(71) Applicant: BROTHER KOGYO KABUSHIKI KAISHA, Nagoya (JP)

(72) Inventors: Fumiya NAKAMURA, Nagoya (JP); Masahiro HAYASHI, Anjo (JP); Naoya OKAZAKI, Hashima (JP); Yuma TANABE, Nagoya (JP); Satoru OKI, Nagoya (JP); Yuji FUKUTA, Nagoya (JP)

(73) Assignee: BROTHER KOGYO KABUSHIKI KAISHA, Nagoya (JP)

(21) Appl. No.: 18/930,356

(22) Filed: Oct. 29, 2024

(30) Foreign Application Priority Data
Nov. 7, 2023 (JP) 2023-190440

(51) Int. Cl. B41J 2/175

(52) U.S. Cl. CPC B41J 2/17566; B41J 2002/17573; B41J 2002/17576

(57) ABSTRACT

A tank includes a storage chamber, a bottom wall, a top wall, a peripheral wall connecting the bottom and top walls to each other, and an outlet in communication with the storage chamber. The bottom wall extends in a lateral direction crossing an up-down direction and has an inner surface including: a flat part extending in the lateral direction and defining a bottom of the storage chamber; and a protruding part protruding downward from the flat part and defining an extra space in communication with the storage chamber. The outlet is positioned in the extra space. Either the bottom wall or the top wall is integrally molded with the peripheral wall to constitute an integrally-molded wall structure having an aperture, and the other one of the bottom wall and the top wall is liquid-tightly connected to the integrally-molded wall structure while covering the aperture to define the storage chamber.

### REFERENCE TO RELATED APPLICATIONS

This application claims priority from Japanese Patent Application No. 2023-190440 filed on Nov. 7, 2023. The entire content of the priority application is incorporated herein by reference.

### BACKGROUND ART

A prior art discloses an ink tank for storing ink to be supplied to a recording head. This ink tank has a front wall, a right wall, a left wall, a top wall, and a bottom wall all of which in combination define an interior space of the ink tank. The ink tank is open on a rear surface thereof. The shape of the interior space of the ink tank is defined by a mold, which is pulled out rearwardly from the open rear surface of the ink tank. The open rear surface of the ink tank is subsequently sealed by welding a film to rear edges of the right wall, left wall, top wall, and bottom wall. In the interior space of the ink tank, a plurality of partitioning walls extending in the front-rear and up-down directions are arranged at intervals in a left-right direction, thereby dividing the interior space of the ink tank into a plurality of ink chambers.

The bottom wall has an upper-level wall, a lower-level wall positioned lower than the upper-level wall, and a connecting wall connecting the upper-level wall to the lower-level wall. An opening is located below the upper-level wall. The opening communicates with the recording head through an ink outflow channel.

### SUMMARY

Since the shape of the internal space of the above-described ink tank is defined by a mold that was pulled out through the open rear surface of the ink tank, the open rear surface is sealed with a film. This structure tends to suffer variations in volumes of the ink chambers, which results in poor volumetric accuracy.

In view of the foregoing, it is an object of the present disclosure to provide a tank and a liquid-consuming device capable of enhancing volumetric accuracy of a storage chamber for storing liquid.

In order to attain the above and other objects, according to one aspect, the present disclosure provides a tank including a storage chamber, a bottom wall, a top wall, a peripheral wall, and an outlet. The storage chamber is for storing liquid therein. The bottom wall extends in a lateral direction crossing an up-down direction. The bottom wall has an inner surface including: a flat part extending in the lateral direction and defining a bottom of the storage chamber; and a protruding part protruding downward from the flat part and defining an extra space in communication with the storage chamber. The top wall is positioned above the bottom wall and extending in the lateral direction. The peripheral wall extends in the up-down direction and connects the bottom wall to the top wall. The outlet is for discharging the liquid in the storage chamber. The outlet is positioned in the extra space. Either one of the bottom wall and the top wall is integrally molded with the peripheral wall to constitute an integrally-molded wall structure having an aperture, and a remaining one of the bottom wall and the top wall is liquid-tightly connected to the integrally-molded wall structure while covering the aperture to define the storage chamber.

With this structure, since the outlet is positioned in the extra space defined by the protruding part of the inner surface of the bottom wall that protrudes downward from the flat part of the inner surface, the liquid in the storage chamber can be readily used up. Further, since either the bottom wall or the top wall is connected to the integrally-molded wall structure in a liquid-tight manner, a film needs not be used to define the storage chamber in the lateral direction crossing the up-down direction. Hence, this configuration is likely to result in higher volumetric accuracy of the storage chamber.

According to another aspect, the present disclosure also provides a tank including a storage chamber, a bottom wall, a top wall, and an outflow tube. The storage chamber is for storing liquid therein. The top wall opposes the bottom wall in an up-down direction and defines a top of the storage chamber. The wall has a through-hole. The outflow tube is positioned in the storage chamber and extends in the up-down direction to have an outlet at a bottom thereof. The outflow tube defines therein an outflow channel in communication with the storage chamber through the outlet. The outflow channel is in communication with an outside of the tank through the through-hole to allow the liquid in the storage chamber to flow to the outside of the tank through the outlet and the through-hole. The bottom wall has an inner surface including: a flat part extending in a lateral direction crossing the up-down direction and defining a bottom of the storage chamber; and a protruding part extending downward from the flat part and defining an extra space in communication with the storage chamber. The outlet is positioned in the extra space.

With this structure, the liquid in the storage chamber can be used up readily, since the outlet is positioned in the extra space defined by the protruding part of the inner surface of the bottom wall that protrudes downward from the flat part of the inner surface of the bottom wall. Further, since the outflow tube defines therein the outflow channel that extends in the up-down direction through the storage chamber from the through-hole in the top wall to the outlet positioned in the extra space. Therefore, the outflow channel can be made shorter than if the outflow channel were to extend from the outlet first in the lateral direction crossing the up-down direction and then upward along an outer surface of the tank. Still further, since a film needs not be attached the outer surface of the tank to define the outflow channel, leakage of liquid resulting from a damage to the film is unlikely to occur. Without a risk of damage to the film, the strength of the tank can be enhanced.

According to still another aspect, the present disclosure also provides a tank including a storage chamber, a top wall, a bottom wall, a peripheral wall, and an injection opening. The storage chamber is for storing liquid therein. The top wall defines a top of the storage chamber in an up-down direction. The bottom wall is positioned below the top wall and defines a bottom of the storage chamber in the up-down direction. The peripheral wall defines an end of the storage chamber in a lateral direction crossing the up-down direction. The injection opening penetrates the top wall to allow liquid to be introduced into the storage chamber. The top wall and the peripheral wall are integrally molded to constitute an integrally-molded wall structure. The bottom wall is liquid-tightly connected to the integrally-molded wall structure to define the storage chamber.

With this structure, since the bottom wall is liquid-tightly connected to the wall structure configured of the top wall and the peripheral wall integrally molded together, there is little need to use a film for defining the storage chamber in the lateral direction crossing the up-down direction. Therefore, higher volumetric accuracy is likely to be provided for the storage chamber. Further, since the injection opening for introducing liquid is provided in the top wall that constituting the integrally-molded wall structure, the storage chamber can have more strength, compared to a configuration where the injection opening is provided in a top wall that is not integrally molded with the peripheral wall.

According to still another aspect, the present disclosure also provides a liquid-consuming device including a housing, the tank according to the one aspect, and a head. The tank is positioned in an internal space of the housing. The head includes a nozzle configured to eject the liquid supplied from the tank. The head is positioned rearward of the tank in the internal space of the housing in a front-rear direction orthogonal to the up-down direction. The outlet is positioned frontward of a center of the storage chamber in the front-rear direction.

While the liquid-consuming device is being transported for shipment, for example, conceivably, the device may be arranged in an orientation with its rear side facing toward the bottom due to the need for effective use of space. In this orientation, since the head is located below the tank, the liquid in the storage chamber is likely to flow to the head through the outlet, which may possibly cause the liquid to leak out of the head. However, with the above-described structure, since the outlet is positioned forward of the storage chamber, the outlet can be positioned higher than the level of the liquid in the storage chamber even when the liquid-consuming device is arranged in this orientation with its rear side facing toward the bottom. Hence, with this configuration, the liquid in the storage chamber is less likely to flow to the head through the outlet, thereby inhibiting leakage of liquid from the head.

According to still another aspect, the present disclosure also provides a liquid-consuming device including a housing, the tank according to the one aspect, and a head. The tank is positioned in an internal space of the housing at one side in a left-right direction orthogonal to the up-down direction. The head includes a nozzle configured to eject the liquid supplied from the tank. The head is positioned in the internal space of the housing at an other side opposite the one side in the left-right direction. The outlet is positioned offset toward the one side from a center of the storage chamber in the left-right direction.

While the liquid-consuming device is being transported for shipment, for example, conceivably, the device may be arranged in an orientation with its left or right side facing toward the bottom due to the need for effective use of space. In this orientation, since the head is located below the tank, the liquid in the storage chamber is likely to flow out to the head through the outlet, which may possibly result in leakage of liquid out of the head. However, with the above-described structure, since the outlet is positioned on the one side of the storage chamber in the left-right direction (offset either rightward or leftward from the left-right center of the storage chamber), the outlet can be positioned higher than the level of the liquid in the storage chamber even when the liquid-consuming device is set in an orientation with its left side or right side facing toward the bottom. Hence, with this configuration, the liquid in the storage chamber is less likely to flow, through the outlet, to the head, thereby suppressing leakage of liquid from the head.

### BRIEF DESCRIPTION OF DRAWINGS

FIG. 1 is a perspective view illustrating an external appearance of a multifunction peripheral 10 according to one embodiment.

FIG. 2 is a vertical cross-sectional view schematically illustrating an internal structure of a printing unit 11 of the multifunction peripheral 10.

FIG. 3 is a plan view illustrating arrangement of a carriage 23 and an ink tank 100 of the printing unit 11.

FIG. 4 is a perspective view of an ink tank set 51 of the printing unit 11.

FIG. 5 is a perspective view of the ink tank 100.

FIG. 6 is a vertical cross-sectional view of the ink tank set 51 taken along a plane including an ink chamber 111D.

FIG. 7 is a perspective view of an ink bottle 80.

FIG. 8 is a vertical cross-sectional view of the ink tank set 51 to which the ink bottle 80 is connected taken along a plane including an ink chamber 111A.

FIG. 9 is a horizontal cross-sectional view illustrating four ink chambers 111A, 111B, 111C, and 111D taken along a horizontal plane passing through a portion of the ink tank 100 above a bottom wall 105.

FIG. 10 is a perspective view of the ink tank 100 as viewed from obliquely below.

FIG. 11 is a partially enlarged perspective view of the bottom wall 105 of the ink tank 100.

FIG. 12 is a perspective view illustrating how a sensor 311 is arranged on the ink tank 100.

FIG. 13 is a schematic diagram illustrating the multifunction peripheral 10 arranged in a posture with its rear side facing downward.

FIG. 14 is a schematic diagram illustrating the multifunction peripheral 10 arranged in another posture with its left side facing downward.

FIG. 15 is an explanatory view schematically illustrating how the bottom wall 105 is connected to an integrally-molded wall structure 511 in a liquid-tight manner.

FIG. 16 is another explanatory view schematically illustrating how a top wall 104 is connected to an integrally-molded wall structure 511A in a liquid-tight manner.

FIG. 17 is a vertical cross-sectional view of an ink tank 100A according to a modification to the embodiment taken along a plane including the ink chamber 111D.

FIG. 18 is a perspective view of an ink tank 100B according to another modification to the embodiment in which a sensor 318 is provided.

### DESCRIPTION

Hereinafter, one embodiment of the present disclosure will be described while referring to attached drawings. It should be understood that the following embodiment is merely one example of the disclosure, and that this embodiment may be modified as appropriate without departing from the spirit of the disclosure.

In the following description, both directions of a bidirectional arrow are collectively referred to as a “direction.” In other words, an upward direction and a downward direction are both components of an up-down direction and are opposite to each other. Similarly, a leftward direction and a rightward direction are both components of a left-right direction and are opposite to each other, and a frontward direction (i.e., a forward direction) and a rearward direction are both components of a front-rear direction and are opposite to each other. Additionally, the up-down direction in this embodiment corresponds to the direction of gravity, while the front-rear direction and left-right direction correspond to horizontal directions.

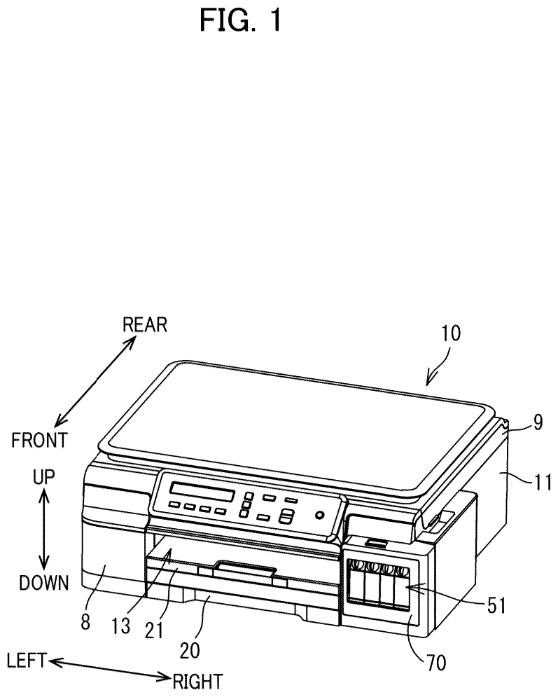

The up-down direction is further defined based on the state or orientation of a multifunction peripheral 10 when the multifunction peripheral 10 is disposed so as to be operable; the front-rear direction is defined based on an assumption that the side of the multifunction peripheral 10 having an opening 13 is the front side nearest a user; and the left-right direction is defined based on the perspective of the user viewing the multifunction peripheral 10 from the front side. The state of the multifunction peripheral 10 in FIG. 1 may be described as an “operable state.” Also, the orientation of the multifunction peripheral 10 in FIG. 1 may be described as an “operable orientation.” The near side of the multifunction peripheral 10 having the opening 13 is the front surface of the multifunction peripheral 10.

In addition, for each component in the multifunction peripheral 10, a center of a component in the left-right direction will be referred to simply as a “left-right center of the component,” a position of the component in the left-right direction will be referred to simply as a “left-right position of the component,” a dimension of the component in the left-right direction will be referred to simply as a “left-right dimension of the component,” and a length of the component in the left-right direction will be referred to simply as a “left-right length of the component.” The same applies to the up-down direction and the front-rear direction.

### [Overall Configuration of the Multifunction Peripheral 10]

As illustrated in FIG. 1, the multifunction peripheral 10 includes a housing 8 having a generally rectangular parallelepiped shape. The multifunction peripheral 10 has a scanning unit 9 and a printing unit 11 arranged in an internal space of the housing 8. The scanning unit 9 is positioned in an upper portion of the internal space. The scanning unit 9 has a scanning function. The printing unit 11 is positioned below the scanning unit 9 in the internal space of the housing 8. The printing unit 11 has a printing function. Incidentally, the multifunction peripheral 10 may not have the scanning unit 9. The multifunction peripheral 10 is an example of a liquid-consuming device of the disclosure.

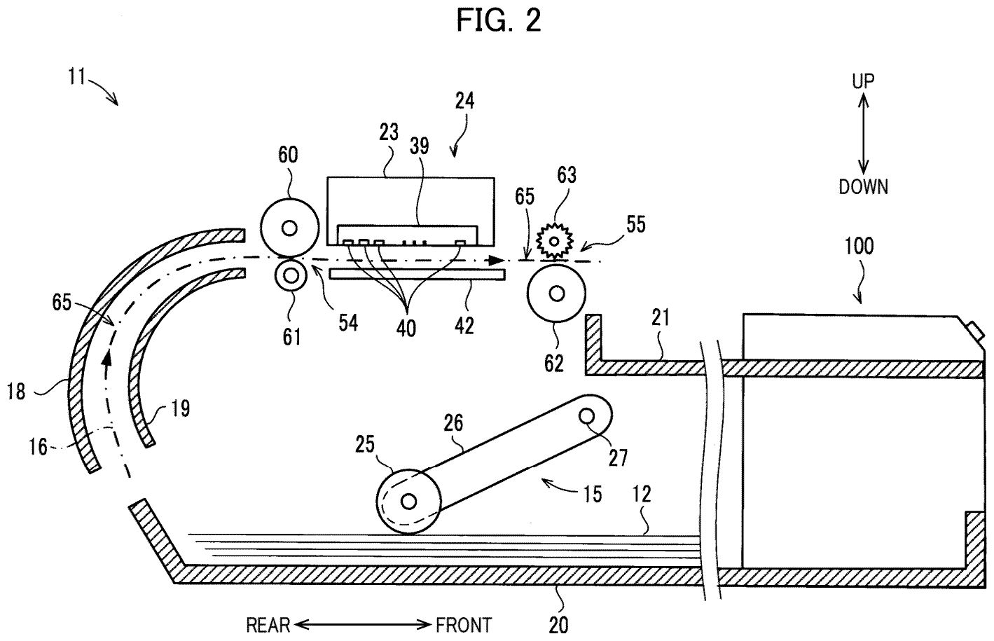

The printing unit 11 is configured to record images on sheets 12 of paper (illustrated in FIG. 2) according to the inkjet recording method. As illustrated in FIGS. 1 and 2, the printing unit 11 includes a feeding unit 15, a sheet tray 20, a discharge tray 21, a conveying path 65, a conveying roller set 54, a recording unit 24, a discharge roller set 55, a platen 42, and an ink tank set 51.

### <Sheet Tray 20 and Discharge Tray 21>

As illustrated in FIG. 1, the opening 13 is formed in the front surface of the multifunction peripheral 10 (i.e., a front surface of the housing 8) at a center thereof in the left-right direction. Through user operations, the sheet tray 20 can be moved in the front-rear direction through the opening 13. As illustrated in FIG. 2, the sheet tray 20 supports a plurality of sheets 12 in a stacked state. The discharge tray 21 is positioned above the sheet tray 20. The discharge tray 21 is movable in the front-rear direction together with the sheet tray 20. The discharge tray 21 can support the sheets 12 discharged by the discharge roller set 55.

### <Feeding Unit 15>

The feeding unit 15 is configured to feed the sheets 12 supported on the sheet tray 20 onto the conveying path 65. As illustrated in FIG. 2, the feeding unit 15 includes a feed roller 25, a feed arm 26, and a shaft 27. The feed roller 25 is rotatably supported on the distal end of the feed arm 26. Upon receipt of a drive force from a conveying motor (not illustrated), the feed roller 25 rotates in a direction for conveying the sheets 12 in a conveying direction 16. Hereinafter, the rotation of the feed roller 25, a conveying roller 60 and a discharge roller 62 (described later) for conveying the sheets 12 in the conveying direction 16 will be called “forward rotation.” The shaft 27 is supported by a frame of the printing unit 11. The feed arm 26 is pivotably supported by the shaft 27. The feed arm 26 is urged toward the sheet tray 20 by its own weight or an elastic force of a spring or the like.

### <Conveying Path 65>

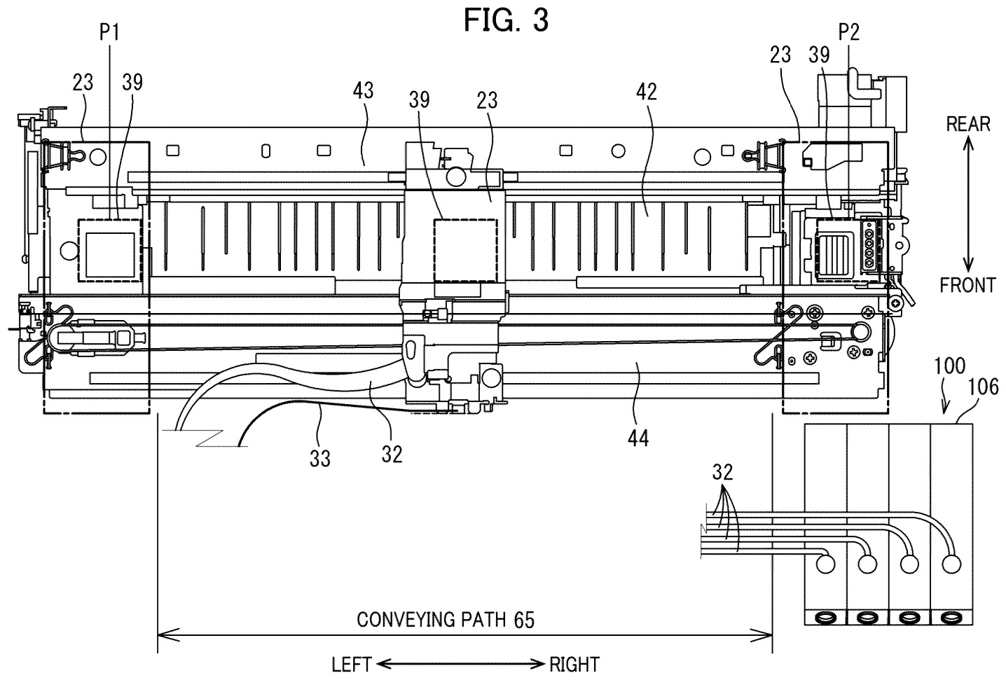

As illustrated in FIG. 2, the conveying path 65 is a space defined by an outer guide member 18 and an inner guide member 19 opposing each other with a prescribed gap therebetween, for example. The conveying path 65 extends from a rear end of the sheet tray 20 toward the rear of the printing unit 11, extends upward therefrom while making a U-turn, and passes through a space between the recording unit 24 and the platen 42 to reach the discharge tray 21. As illustrated in FIGS. 2 and 3, a part of the conveying path 65 between the conveying roller set 54 and the discharge roller set 55 is positioned at an approximate left-right center of the multifunction peripheral 10 and extends in the front-rear direction. In FIG. 2, the conveying direction 16 of the sheets 12 on the conveying path 65 is indicated by arrows in one-dot chain lines.

### <Conveying Roller Set 54>

As illustrated in FIG. 2, the conveying roller set 54 is positioned upstream of the recording unit 24 in the conveying direction 16. The conveying roller set 54 includes the conveying roller 60 and a pinch roller 61. The conveying roller 60 and the pinch roller 61 oppose each other in the up-down direction. The conveying roller 60 is rotatable by the drive force transmitted from the conveying motor. The pinch roller 61 is rotatable following the rotation of the conveying roller 60. As the conveying roller 60 makes the forward rotation by a forward drive of the conveying motor, the sheet 12 nipped between the conveying roller 60 and the pinch roller 61 is conveyed in the conveying direction 16.

### <Discharge Roller Set 55>

As illustrated in FIG. 2, the discharge roller set 55 is positioned downstream of the recording unit 24 in the conveying direction 16. The discharge roller set 55 includes the discharge roller 62 and a spur 63. The discharge roller 62 and the spur 63 oppose each other in the up-down direction. The discharge roller 62 is rotatable by the drive force transmitted from the conveying motor. The spur 63 is rotatable following the rotation of the discharge roller 62. As the discharge roller 62 makes the forward rotation by the forward drive of the conveying motor, the sheet 12 nipped between the discharge roller 62 and the spur 63 is conveyed in the conveying direction 16.

### <Recording Unit 24>

As illustrated in FIG. 2, the recording unit 24 is positioned between the conveying roller set 54 and the discharge roller set 55 in the conveying direction 16. The recording unit 24 opposes the platen 42 in the up-down direction across the conveying path 65. The recording unit 24 is positioned above the conveying path 65. The recording unit 24 includes a carriage 23, and a recording head 39.

As illustrated in FIG. 3, the carriage 23 is supported on guide rails 43 and 44. The guide rails 43 and 44 are supported by the frame of the printing unit 11. The guide rails 43 and 44 are spaced apart from each other in the front-rear direction with each extending in the left-right direction. Each of the guide rails 43 and 44 extends to span across the conveying path 65 in the left-right direction such that both ends of each guide rail 43, 44 are positioned outward of the conveying path 65 in the left-right direction. The carriage 23 is coupled to a well-known belt mechanism provided on the guide rail 44. The belt mechanism is configured to be driven by a drive force transmitted from a carriage motor (not illustrated). The carriage 23 is movable in the left-right direction in accordance with movement of the belt mechanism. In FIG. 3, a range in which the carriage 23 is movable in the left-right direction is indicated by one-dot chain lines. The carriage 23 is movable in the left-right direction between a rightmost position further rightward of the conveying path 65 and a leftmost position further leftward of the conveying path 65.

The recording head 39 is connected to an ink tank 100 (described later) by ink tubes 32. The recording head 39 is electrically connected to a control board incorporating a controller (not illustrated) thereon by a flexible flat cable 33. The ink tubes 32 and the flexible flat cable 33 both extend from the carriage 23. The ink tubes 32 serve to supply ink stored in the ink tank 100 to the recording head 39. The flexible flat cable 33 is configured to transmit control signals outputted from the controller to the recording head 39.

As illustrated in FIGS. 2 and 3, the carriage 23 supports the recording head 39. The recording head 39 is movable in the left-right direction between a standby position P1 and a maintenance position P2 in accordance with the movement of the carriage 23. At the standby position P1, the recording head 39 is positioned leftward of the conveying path 65. At the maintenance position P2, the recording head 39 is positioned rightward of the conveying path 65. A plurality of nozzles 40 is formed in a bottom surface of the recording head 39. The recording head 39 is configured to eject ink through the nozzles 40 in a form of microdroplets. While the carriage 23 moves in the left-right direction, the recording head 39 is configured to record an image on the sheet 12 supported on the platen 42 by ejecting the ink droplets toward the sheet 12. The recording head 39 is an example of a head of the disclosure. The leftward direction is an example of an other side in the left-right direction.

### <Platen 42>

As illustrated in FIGS. 2 and 3, the platen 42 is positioned between the conveying roller set 54 and the discharge roller set 55 in the conveying direction 16. The platen 42 opposes the recording unit 24 in the up-down direction. The platen 42 function to support each sheet 12 conveyed by the conveying roller set 54 from below.

### <Ink Tank Set 51>

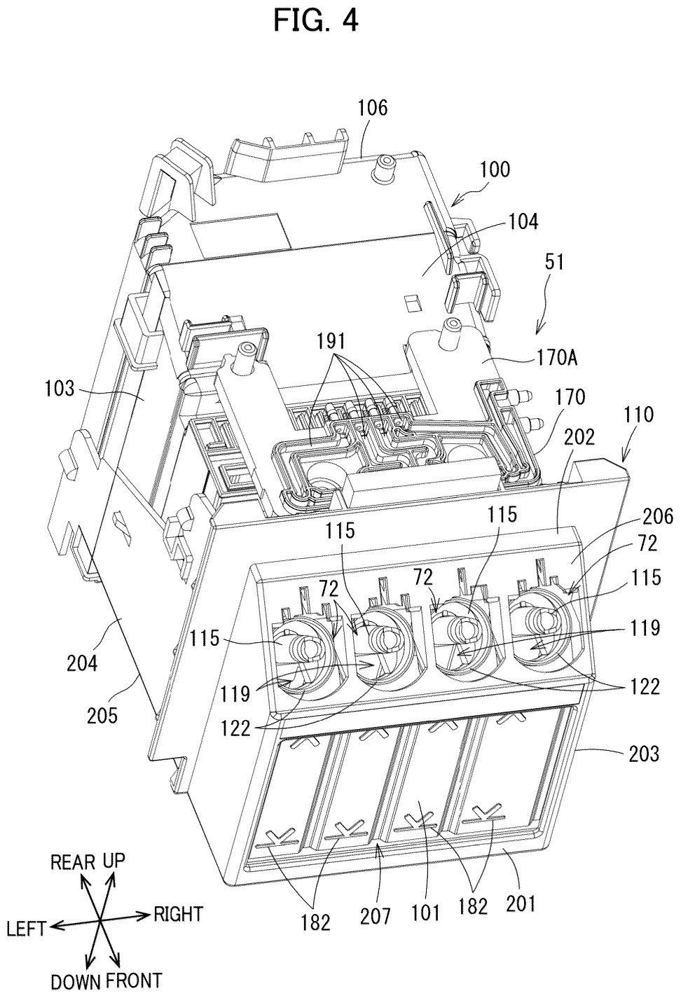

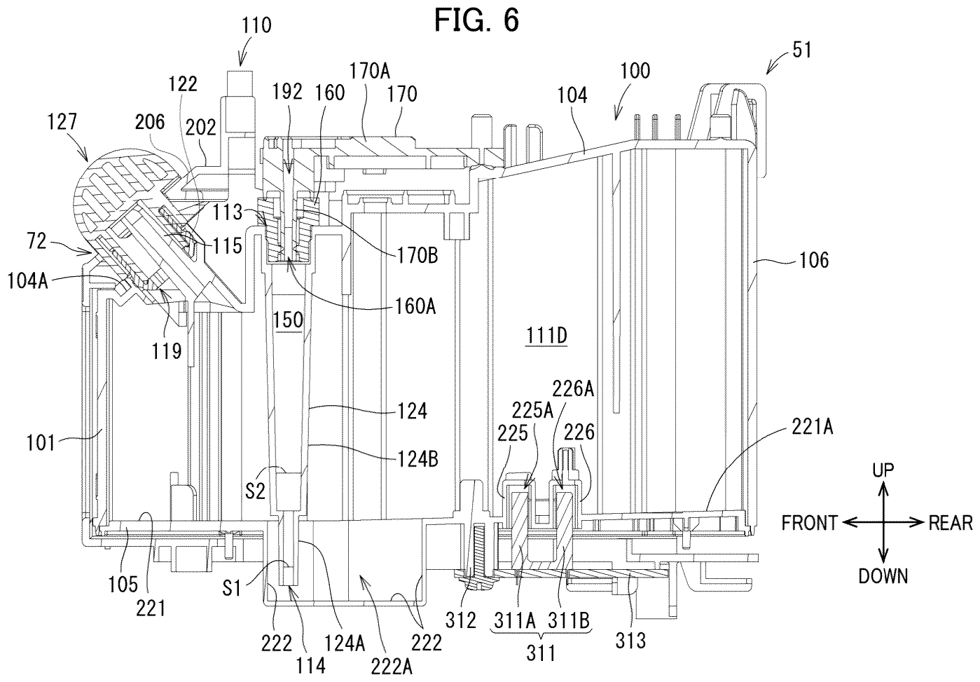

As illustrated in FIGS. 4 and 6, the ink tank set 51 includes the ink tank 100, a tank cover 110, and tank caps 127. Please note the tank caps 127 are not illustrated in FIG. 4. The ink tank 100 is an example of a tank of the disclosure.

As illustrated in FIG. 1, the ink tank set 51 is positioned inside the multifunction peripheral 10. The ink tank set 51 is fixed on the inside of the housing 8 so that a user cannot easily remove the ink tank set 51 from the housing 8. An opening is formed in the front surface of the housing 8 at a position near a right end thereof. The ink tank set 51 is positioned to the rear of this opening. In other words, the ink tank set 51 is arranged in the internal space of the housing 8 at a position offset toward the right from a left-right center of the housing 8. The rightward direction is an example of one side in the left-right direction.

As illustrated in FIG. 1, a cover 70 is provided on the housing 8 over the opening formed in the front surface of the housing 8. The cover 70 has a bottom end defining a pivot axis extending in the left-right direction. The cover 70 is pivotable about the pivot axis, relative to the housing 8, between a covering position (illustrated in FIG. 1) for covering the opening in the housing 8 and an uncovering position for exposing the opening in the housing 8 to the outside of the multifunction peripheral 10. In other words, the cover 70 is pivotable between the covering position for covering the ink tank set 51 and the uncovering position for exposing the ink tank set 51 to the outside of the multifunction peripheral 10. Since the cover 70 has an opening therein, a portion of the ink tank set 51 can be exposed to the outside of the multifunction peripheral 10 through the opening in the cover 70 even when the cover 70 is at the covering position. Here, “a portion of the ink tank set 51 is exposed to the outside of the multifunction peripheral 10 through the opening in the cover 70” denotes a state that a user can visually confirm at least a part of the ink tank set 51 through the opening in the cover 70, and does not mean that a part of the ink tank set 51 protrudes out from the multifunction peripheral 10 through the opening in the cover 70.

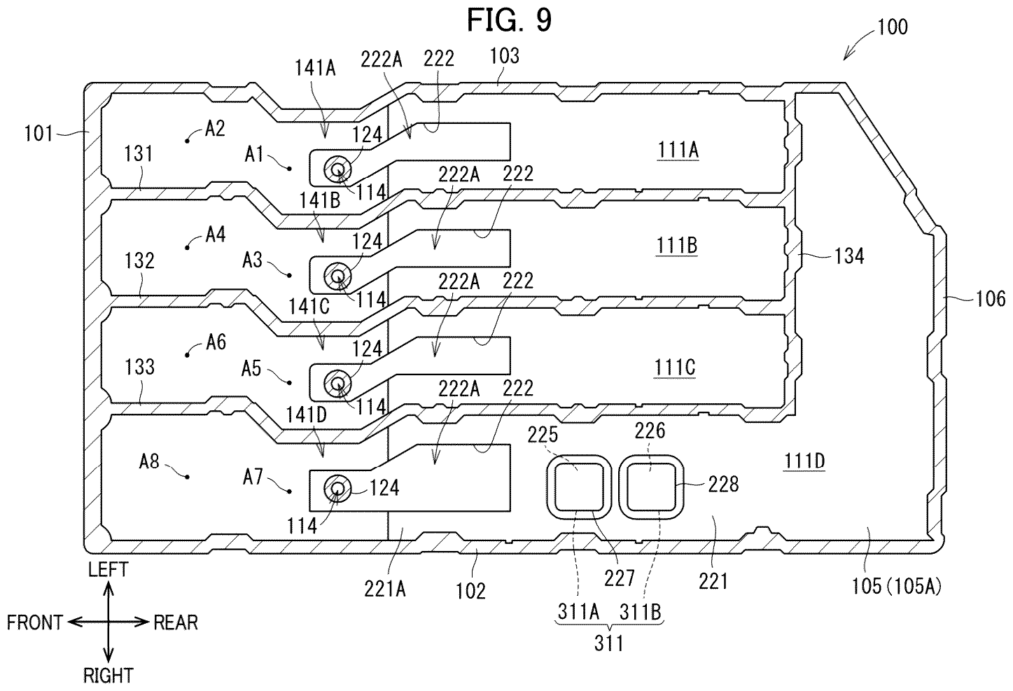

As illustrated in FIGS. 6 and 9, the ink tank 100 has an internal space in which four ink chambers 111A, 111B, 111C, and 111D are defined. The four ink chambers 111A, 111B, 111C, and 111D are juxtaposed in the left-right direction, in order from the left. The three ink chambers 111A, 111B, and 111C respectively store ink of different colors, i.e., ink in one of the colors of yellow, cyan, and magenta. The ink chamber 111D stores black ink therein. The ink is an example of liquid of the disclosure.

Incidentally, the ink may be pigment ink containing pigments, or dye ink containing dyes. Further, each ink chamber 111A, 111B, 111C, 111D may store, instead of the ink, cleaning solution including water. The cleaning solution is another example of the liquid of the disclosure.

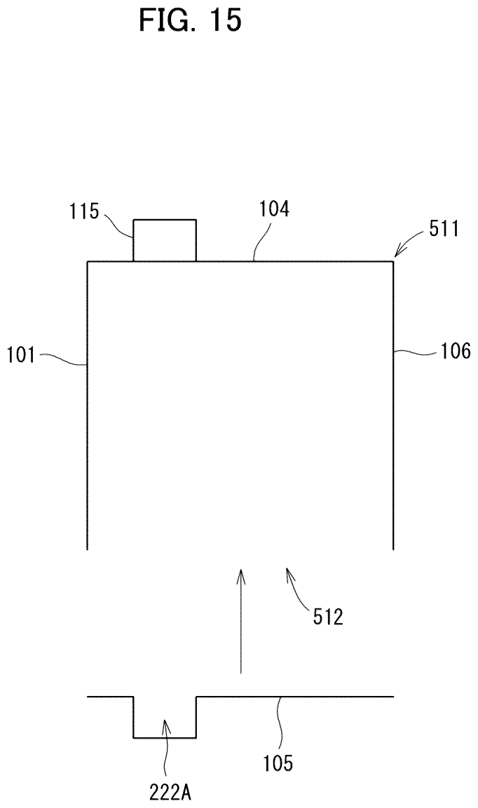

As illustrated in FIGS. 4, 5, and 9, the ink tank 100 has a generally rectangular parallelepiped external shape. The ink tank 100 has a front wall 101, a right wall 102, a left wall 103, a top wall 104, a bottom wall 105, a rear wall 106, and four partition walls 131, 132, 133, and 134. The front wall 101, right wall 102, left wall 103, top wall 104, rear wall 106, and four partition walls 131, 132, 133, and 134 are integrally formed by injection molding, for example, by injection molding using a resin material. As illustrated in FIG. 15, a wall structure 511 is an integrally-molded product manufactured by injection molding, and is open downward to provide an aperture 512. The bottom wall 105 is a molded product that is manufactured separately from the integrally-molded wall structure 511. The bottom wall 105 is molded using the same resin material as the integrally-molded wall structure 511.

The bottom wall 105 is welded to a bottom end of the integrally-molded wall structure 511 with the bottom wall 105 covering the aperture 512 of the wall structure 511. In this way, the bottom wall 105 is connected to the bottom end of the integrally-molded wall structure 511 in a liquid-tight manner. Here, the welding may be performed through: thermal welding using external heat for heating the walls; high-frequency welding or ultrasonic welding using high-frequency waves or ultrasonic waves for heating the walls; and laser welding using a laser beam to heat the walls, for example.

The front wall 101, right wall 102, left wall 103, top wall 104, and rear wall 106 have light transmittance of such a degree that levels of the ink in the respective ink chambers inside the ink tank 100 are visible from the outside the ink tank 100. The front wall 101 of the ink tank 100 has a front surface 101B in which viewing surfaces 233 are formed so that a user can visually confirm the four ink chambers 111A, 111B, 111C, and 111D from its front side through the corresponding viewing surfaces 233.

The three partition walls 131, 132, and 133 are spaced at intervals in the left-right direction. Each of the partition walls 131, 132, and 133 has a flat plate shape extending in both the front-rear and up-down directions. The partition wall 131 is positioned to the right of the left wall 103 and is spaced apart from the left wall 103. The partition wall 132 is positioned to the right of the partition wall 131 and is spaced apart from the partition wall 131. The partition wall 133 is positioned to the right of the partition wall 132 and is spaced apart from the partition wall 132. Front edges of the respective partition walls 131, 132, and 133 are connected to a rear surface of the front wall 101. Top edges of the respective partition walls 131, 132, and 133 are connected to a bottom surface of the top wall 104. Bottom edges of the respective partition walls 131, 132, and 133 are connected to a top surface 105A of the bottom wall 105.

The partition wall 134 is positioned rearward of the three partition walls 131, 132, and 133. The partition wall 134 has a flat plate shape extending in both the up-down and left-right directions. Rear edges of the respective partition walls 131, 132, and 133 are connected to a front surface of the partition wall 134. Specifically, the partition wall 134 extends leftward from the rear edge of the partition wall 133 to a right surface of the left wall 103.

The ink chamber 111A is defined by the rear surface of the front wall 101, the right surface of the left wall 103, the bottom surface of the top wall 104, the top surface 105A of the bottom wall 105, a left surface of the partition wall 131, and a front surface of the partition wall 134.

The ink chamber 111A has an offset chamber 141A. The offset chamber 141A is positioned forward of a front-rear center of the ink chamber 111A. The offset chamber 141A is a portion of the ink chamber 111A defined by a curved portion of the left wall 103 and a curved portion of the partition wall 131 both of which are positioned forward of the front-rear center of the ink chamber 111A, the curved portions opposing each other in the left-right direction and curving to be convex toward the right. Hence, the offset chamber 141A defines a left-right center A1 that is offset toward the right from a left-right center A2 of the ink chamber 111A.

The ink chamber 111B is defined by the rear surface of the front wall 101, the bottom surface of the top wall 104, the top surface 105A of the bottom wall 105, a right surface of the partition wall 131, a left surface of the partition wall 132, and the front surface of the partition wall 134.

The ink chamber 111B has an offset chamber 141B. The offset chamber 141B is positioned forward of a front-rear center of the ink chamber 111B. The offset chamber 141B is a portion of the ink chamber 111B defined by the curved portion of the partition wall 131 and a curved portion of the partition wall 132 both of which are positioned forward of the front-rear center of the ink chamber 111B, the curved portions opposing each other in the left-right direction and curving to be convex toward the right. Hence, the ink chamber 111B defines a left-right center A3 that is offset rightward from a left-right center A4 of the ink chamber 111B.

The ink chamber 111C is defined by the rear surface of the front wall 101, the bottom surface of the top wall 104, the top surface 105A of the bottom wall 105, a right surface of the partition wall 132, a left surface of the partition wall 133, and the front surface of the partition wall 134. The ink chamber 111C is an example of a second storage chamber.

The ink chamber 111C has an offset chamber 141C. The offset chamber 141C is positioned forward of a front-rear center of the ink chamber 111C. The offset chamber 141C is a portion of the ink chamber 111C defined by the curved portion of the partition wall 132 and a curved portion of the partition wall 133 both of which are positioned forward of the front-rear center of the ink chamber 111C, the curved portions opposing each other in the left-right direction and curving to be convex toward the right. Hence, the offset chamber 141C defines a left-right center A5 that is offset toward the right from a left-right center A6 of the ink chamber 111C.

The ink chamber 111D is defined by the rear surface of the front wall 101, a left surface of the right wall 102, the bottom surface of the top wall 104, the top surface 105A of the bottom wall 105, a front surface of the rear wall 106, a right surface of the partition wall 133, and a rear surface of the partition wall 134. The ink chamber 111D has an L-shape, first extending rearward from the rear surface of the front wall 101 and then bending leftward. A rear end portion of the ink chamber 111D extending in the left-right direction is positioned rearward of the three ink chambers 111A, 111B, and 111C. The ink chamber 111D has a capacity larger than a capacity of each of the ink chambers 111A, 111B, and 111C.

Incidentally, the front wall 101, right wall 102, rear wall 106, partition wall 133, and partition wall 134 need not be perfectly parallel to the up-down direction.

The ink chamber 111D is an example of a storage chamber of the disclosure. The front wall 101, right wall 102, rear wall 106, partition walls 133 and 134 are examples of a peripheral wall of the disclosure. The partition wall 133 is also an example of a partition wall of the disclosure.

The ink chamber 111D has an offset chamber 141D. The offset chamber 141D is positioned forward of a front-rear center of the ink chamber 111D. The offset chamber 141D is a portion of the ink chamber 111D defined by the curved portion of the partition wall 133 and a frontward portion of the right wall 102 opposing each other in the left-right direction at a position forward of the front-rear center of the ink chamber 111D. Hence, the offset chamber 141D defines a left-right center A7 that is offset rightward from a left-right center A8 of the ink chamber 111D.

In each of the ink chambers 111A, 111B, 111C, and 111D, a protruding chamber 222 is formed at the bottom thereof. The protruding chamber 222 protrudes downward from the bottom wall 105 defining the corresponding ink chamber 111A, 111B, 111C, 111D. Each protruding chamber 222 defines therein an extra space 222A in communication with the corresponding ink chamber 111A, 111B, 111C, 111D. Each space 222A (protruding chamber 222) is elongated in the front-rear direction and is generally rectangular parallelepiped in shape. Each space 222A (protruding chamber 222) extends in the front-rear direction such that each protruding chamber 222 has a front end at an approximate front-rear center of the corresponding offset chamber 141A, 141B, 141C, 141D, and a rear end at an approximate front-rear center of the corresponding ink chamber 111A, 111B, 111C, 111D. With respect to the left-right direction, each space 222A (protruding chamber 222) is positioned at the corresponding left-right center A1, A3, A5, and A7 of the corresponding offset chambers 141A, 141B, 141C, and 141D.

Specifically, the top surface 105A of the bottom wall 105 in each of the ink chambers 111A, 111B, 111C, and 111D is configured of: a flat surface 221 extending in the front-rear and left-right directions; wall surfaces defining the extra space 222A in the corresponding protruding chamber 222; and a sloped surface 221A. Hereinafter, as a matter of convenience, the wall surfaces defining the space 222A in the corresponding protruding chamber 222 will be referred to as wall surfaces 222, whenever appropriate.

The flat surface 221 extends in the front-rear and left-right directions. The flat surface 221 defines a bottom of the corresponding ink chamber 111A, 111B, 111C, 111D. The wall surfaces 222 defining the space 222A protrude downward from the flat surface 221. The sloped surface 221A also defines the bottom of the corresponding ink chamber 111A, 111B, 111C, 111D. The sloped surface 221A extends in the front-rear direction from a position corresponding to an approximate front-rear center of the space 222A (protruding chamber 222) to the front surface of the rear wall 106 defining the corresponding ink chamber 111A, 111B, 111C, 111D. In the left-right direction, the sloped surface 221A extends to span between the right surface of the left wall 103 and the left surface of the right wall 102. The sloped surface 221A is sloped relative to the front-rear direction such that the sloped surface 221A extends diagonally downward toward the corresponding space 222A. With this configuration, the ink stored in each ink chamber 111A, 111B, 111C, 111D is likely to flow along the sloped surface 221A toward the corresponding space 222A to be collected therein. The top surface 105A of the bottom wall 105 is an example of an inner surface of the bottom wall of the disclosure. The flat surface 221 is an example of a flat part of the inner surface of the bottom wall. The wall surfaces 222 are an example of a protruding part of the inner surface of the bottom wall. The sloped surface 221A is an example of a sloped part of the inner surface of the bottom wall.

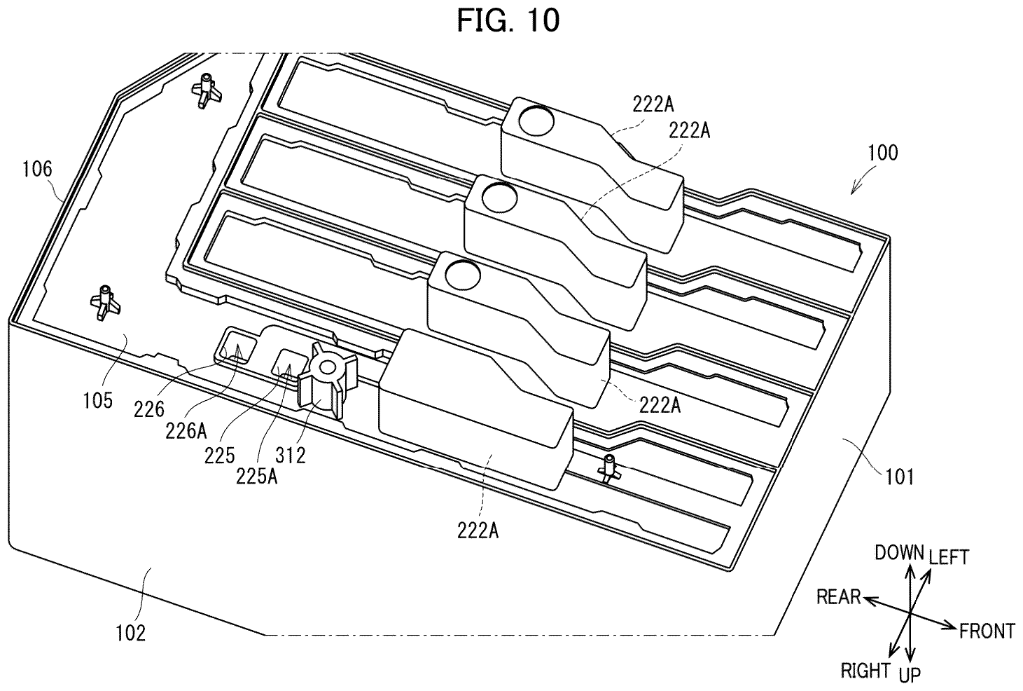

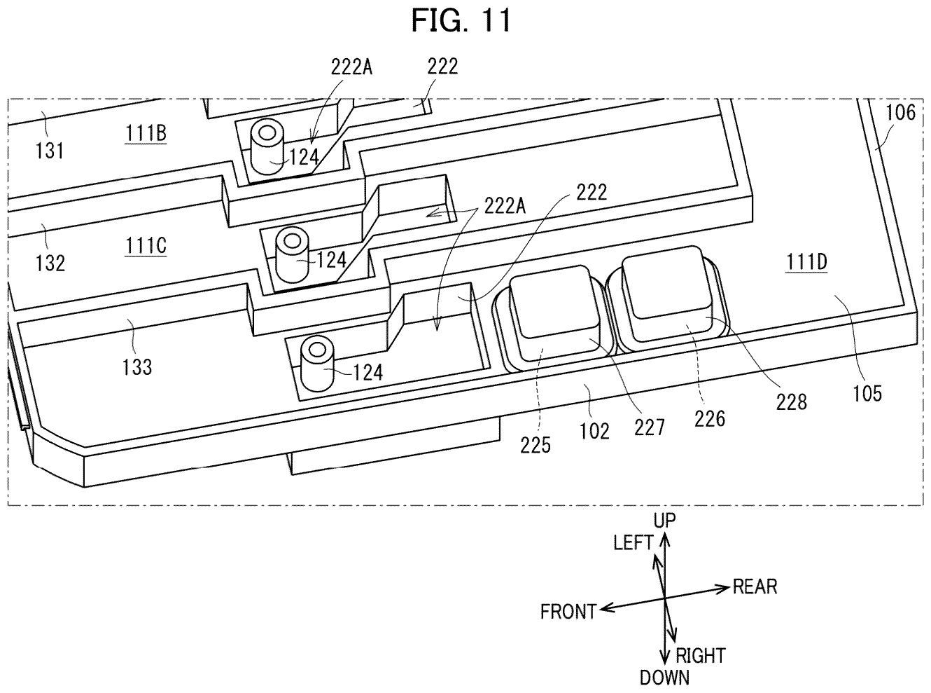

As illustrated in FIGS. 9, 10, and 11, a front accommodating part 225 and a rear accommodating part 226 are positioned to the rear of the offset chamber 141D. The rear accommodating part 226 is positioned rearward of the front accommodating part 225 and is spaced apart from the front accommodating part 225. The rear accommodating part 226 opposes the front accommodating part 225 in the front-rear direction. The front accommodating part 225 and rear accommodating part 226 each protrude upward from the bottom wall 105 to define a substantially cubic-shaped front accommodating space 225A and a substantially cubic-shaped rear accommodating space 226A, respectively. The front accommodating part 225 and rear accommodating part 226 are both open downward. The front accommodating part 225 in its entirety in the ink chamber 111D is covered by a front cover 227. The front cover 227 is made of silicone. Likewise, the rear accommodating part 226 in its entirety in the ink chamber 111D is covered by a rear cover 228. The rear cover 228 is made of silicone. The front accommodating part 225 is an example of a first accommodating part of the disclosure. The front accommodating space 225A is an example of a first accommodation space of the disclosure. The front cover 227 is an example of a first cover of the disclosure. The rear accommodating part 226 is an example of a second accommodating part of the disclosure. The rear accommodating space 226A is an example of a second accommodation space of the disclosure. The rear cover 228 is an example of a second cover of the disclosure.

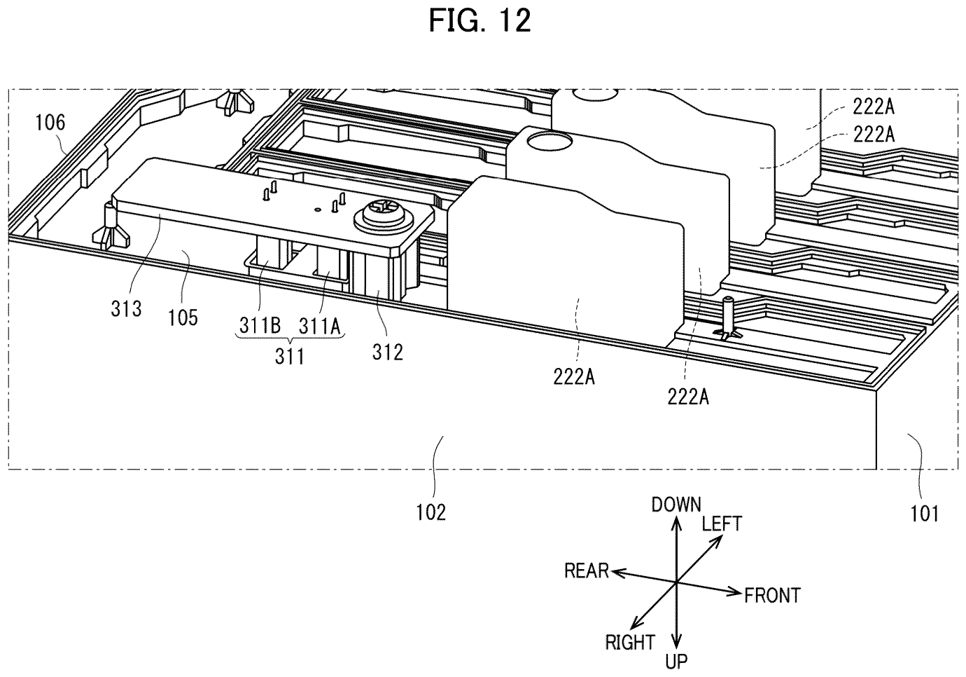

As illustrated in FIGS. 6, 9, and 12, a sensor 311 is arranged rearward of the offset chamber 141D. The sensor 311 is configured to detect a level of the ink in the ink chamber 111D. The sensor 311 includes a light-emitting element 311A, and a light-receiving element 311B. The light-emitting element 311A is inserted in the front accommodating space 225A from below and is disposed in the front accommodating space 225A. The light-receiving element 311B is inserted in the rear accommodating space 226A from below and is disposed in the rear accommodating space 226A. The light-emitting element 311A and the light-receiving element 311B are fixed to a flat plate-shaped circuit board 313. The circuit board 313 is fixed to a protruding part 312 that protrudes downward from the bottom wall 105. In this way, the light-emitting element 311A and the light-receiving element 311B are held in the front accommodating space 225A and rear accommodating space 226A, respectively.

The light-emitting element 311A is configured to emit light rearwardly toward the light-receiving element 311B. When the liquid surface of the ink in the ink chamber 111D is positioned above an optical path of the light emitted from the light-emitting element 311A toward the light-receiving element 311B, the light emitted from the light-emitting element 311A travels rearward, while passing through the front accommodating part 225 and front cover 227 and then through the ink, and arrives at the rear accommodating part 226. The light arriving at the rear accommodating part 226 travels rearward while passing through the rear cover 228 and rear accommodating part 226 and is finally received by the light-receiving element 311B. However, if the liquid surface of the ink in the ink chamber 111D is positioned below the optical path of the light emitted from the light-emitting element 311A toward the light-receiving element 311B, the light emitted from the light-emitting element 311A is refracted at the front cover 227 and does not reach the light-receiving element 311B.

The light-receiving element 311B is configured to receive the light emitted from the light-emitting element 311A. When receiving the light emitted from the light-emitting element 311A, the light-receiving element 311B is configured to output a detection signal to a controller (not illustrated). The sensor 311 is an example of a sensor of the disclosure. The detection signal is an example of a second signal. When not receiving the light emitted from the light-emitting element 311A, the light-receiving element 311B is configured to output a non-detection signal to the controller. The non-detection signal is an example of a first signal.

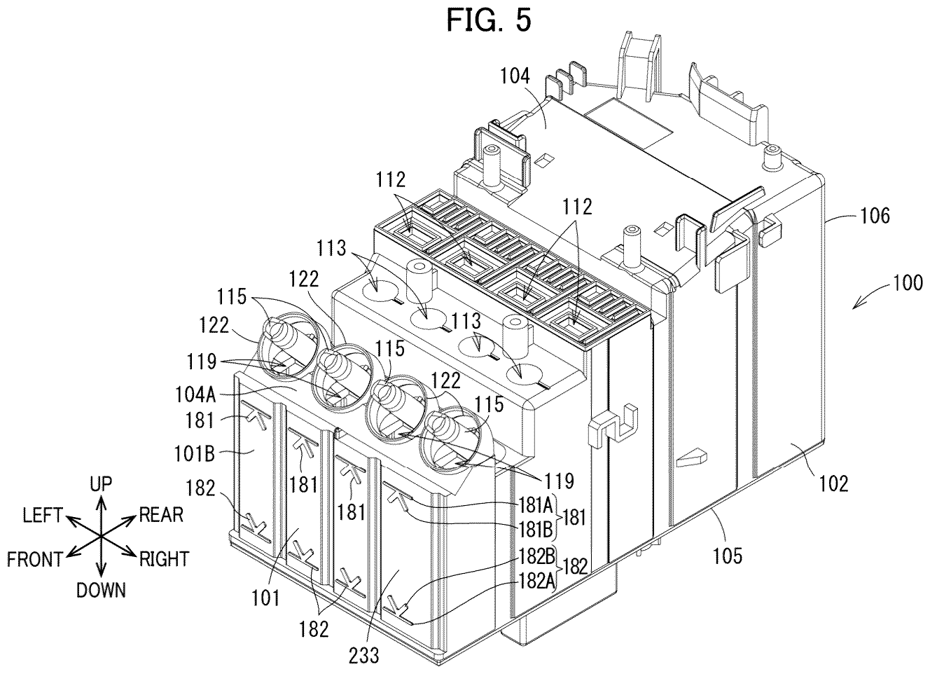

As illustrated in FIG. 5, four upper marks 181 and four lower marks 182 are arranged on the front surface 101B of the front wall 101. The four upper marks 181 are spaced apart from one another other in the left-right direction, and the four lower marks 182 are spaced apart from one another in the left-right direction. The upper marks 181 are positioned higher than a center region of the front surface 101B in the up-down direction. The upper marks 181 are positioned in an upper region on the front surface 101B. The upper marks 181 are positioned below a top edge of the front surface 101B. Each upper mark 181 includes a top line 181A extending in the left-right direction, and an up arrow 181B positioned beneath the top line 181A. The point of the up arrow 181B is positioned on a left-right center of the top line 181A. The left-right positions of the upper marks 181 are aligned with the corresponding ink chambers 111A, 111B, 111C, and 111D. The upper marks 181 indicate that the ink is full in the corresponding ink chambers 111A, 111B, 111C, and 111D when the liquid surfaces of the ink in the respective ink chambers 111A, 111B, 111C, and 111D are at the positions of the top lines 181A. The upper marks 181 are an example of a first mark of the disclosure. The position (height) of each top line 181A is an example of a first level.

The four lower marks 182 are positioned below the center region on the front surface 101B of the front wall 101. The lower marks 182 are located in a lower region on the front surface 101B. The lower marks 182 are positioned higher than a bottom edge of the front surface 101B. Each lower mark 182 includes a bottom line 182A extending in the left-right direction, and a down arrow 182B positioned above the bottom line 182A. The point of the down arrow 182B is positioned on a left-right center of the bottom line 182A. The left-right positions of the lower marks 182 are aligned with the corresponding ink chambers 111A, 111B, 111C, and 111D. The lower marks 182 indicate that the corresponding ink chambers 111A, 111B, 111C, and 111D should be replenished with ink when the liquid surfaces of the ink in the respective ink chambers 111A, 111B, 111C, and 111D are at the positions of the bottom lines 182A. The lower marks 182 are an example of a second mark of the disclosure. The position (height) of each bottom line 182A is an example of a second level.

Incidentally, each upper mark 181 may be configured as a mark including only one of the top line 181A and the up arrow 181B. Likewise, each lower mark 182 may be configured as a mark including only one of the bottom line 182A and the down arrow 182B. Further, the four upper marks 181 and four lower marks 182 may be integrally molded with the front surface 101B, or may be configured as stickers affixed to the front surface 101B.

The top wall 104 has a top surface configured of a plurality of surfaces extending in the front-rear and left-right directions. The top wall 104 has air communication ports 112 to allow communication of the respective ink chambers 111A, 111B, 111C, and 111D with ambient air. The air communication ports 112 penetrate the top wall 104 in the up-down direction. The top surface of the top wall 104 further has a sloped surface 104A. The sloped surface 104A constitutes a front end portion of the top surface of the top wall 104. The sloped surface 104A is sloped relative to the front-rear direction such that the sloped surface 104A extends diagonally downward toward the front. The sloped surface 104A extends in the left-right direction to span between the left and right edges of the ink tank 100.

The top wall 104 also has four openings 113 to provide communication between the corresponding ink chambers 111A, 111B, 111C, and 111D and the exterior of the ink tank 100. The four openings 113 are positioned forward of the corresponding air communication ports 112. The openings 113 are spaced at intervals in the left-right direction. The openings 113 are an example of a through-hole in the top wall of the disclosure.

As illustrated in FIG. 6, an outflow tube 124 is connected to each of the openings 113 in the top wall 104. As illustrated in FIGS. 6 and 9, each outflow tube 124 is a circular tubular member that extends downward from the corresponding opening 113 through the corresponding offset chambers 141A, 141B, 141C, and 141D in the up-down direction. Each outflow tube 124 has a bottom end formed with an outlet 114 that is open downward. Thus, each outflow tube 124 defines an outflow channel 150 therein that extends in the up-down direction from the outlet 114 to the corresponding opening 113. Each outlet 114 is positioned inside the space 222A (protruding chamber 222) of the corresponding ink chamber 111A, 111B, 111C, 111D.

As such, the outlets 114 are positioned rightward of the left-right centers A2, A4, A6, and A8 of the ink chambers 111A, 111B, 111C, and 111D, respectively. Each outlet 114 is also positioned forward of a front-rear center of the space 222A (protruding chamber 222) of the corresponding ink chamber 111A, 111B, 111C, 111D. Further, each outlet 114 is spaced apart from the wall surfaces 222 defining the corresponding space 222A (the protruding chamber 222). Each outlet 114 is positioned below the center of the corresponding space 222A in the up-down direction. Each outlet 114 is positioned slightly above the wall surface 222 defining the bottom of the corresponding space 222A in the protruding chamber 222.

Each outflow tube 124 has a small-diameter portion 124A and a large-diameter portion 124B positioned above the small-diameter portion 124A. The small-diameter portion 124A is cylindrical in shape, and is positioned in the corresponding space 222A (protruding chamber 222). The large-diameter portion 124B has an inner diameter that is larger than an inner diameter of the small-diameter portion 124A. The large-diameter portion 124B is a conical cylinder whose diameter increases toward the top, i.e., toward the corresponding opening 113, in the up-down direction. That is, each outflow tube 124 is tapered toward the corresponding outlet 114. The outflow channel 150 defined in each outflow tube 124 is also tapered toward the outlet 114. More specifically, a cross-sectional area S1 of the outflow channel 150 taken along a horizontal plane in the small-diameter portion 124A is smaller than a cross-sectional area S2 of the outflow channel 150 taken along a horizontal plane in the large-diameter portion 124B.

A rubber seal member 160 is press-fitted into each outflow tube 124 through the corresponding opening 113. The rubber seal member 160 has a through-hole 160A extending in the up-down direction.

Each outflow tube 124 is connected to a corresponding connection part 170 disposed on the top surface of the top wall 104 (see FIGS. 4 and 6). The connection part 170 has a flat base plate 170A, and four cylindrical tubes 170B extending downward from the base plate 170A in the up-down direction. The base plate 170A is detachably fixed to the top wall 104. The base plate 170A has four ink channels 191. Specifically, the ink channels 191 are defined by grooves formed in a top surface of the base plate 170A, and a film bonded to the top surface of the base plate 170A to cover the same. Note that the film is not illustrated in FIGS. 4 and 6. Each ink channel 191 is connected to a corresponding one of the ink tubes 32 connected to the recording head 39. Each tube 170B defines an ink channel 192 therein. Each ink channel 192 communicates with the ink channel 191 in the corresponding tube 170B. Each tube 170B is inserted in a liquid-tight manner in the through-hole 160A of the corresponding rubber seal member 160, such that each ink channel 192 communicates with the outflow channel 150 of the corresponding outflow tube 124. The ink stored in the respective ink chambers 111A, 111B, 111C, and 111D flows to the recording head 39 through the corresponding outflow tubes 124, ink channels 192, ink channels 191, and ink tubes 32. As the ink in the respective ink chambers 111A, 111B, 111C, and 111D is consumed by the recording head 39 ejecting the ink therefrom, air flows into the respective ink chambers 111A, 111B, 111C, and 111D through the respective air communication ports 112.

Four annular walls 122 are also provided on a front end portion of the top wall 104. Each annular wall 122 is cylindrical in shape, and surrounds a tank tube 115 and a communication opening 119. The annular walls 122 extend diagonally upward and forward from the front end portion of the top wall 104 (or the sloped surface 104A), so that the annular walls 122 extend in parallel to the respective tank tubes 115. Hereinafter, the direction in which the annular walls 122 and tank tubes 115 extend from the top wall 104 will be referred to as an extending direction which crosses both the direction of gravity and a horizontal direction. The tank tube 115 protrudes further in the extending direction (farther upward and forward) than a distal end of the corresponding annular wall 122.

Each tank tube 115 is positioned radially inward of the corresponding annular wall 122. The tank tubes 115 are circular tubes that extend diagonally upward and forward from the top wall 104 in the extending direction. Each tank tube 115 has an upper end that is open on the outside of the corresponding ink chamber 111A, 111B, 111C, 111D. Each tank tube 115 has a bottom end that is open on the inside of the corresponding ink chamber 111A, 111B, 111C, 111D. In this way, each tank tube 115 provides communication between the exterior and interior of the corresponding ink chamber 111A, 111B, 111C, 111D. Each tank tube 115 is positioned offset rearward from a center of the corresponding annular wall 122. In other words, when viewed in the extending direction, an axial center of each tank tube 115 is positioned rearward of an axial center of the corresponding annular wall 122. Each tank tube 115 has a protruding end that is divided into two lip portions opposing in the left-right direction, thereby forming a recessed groove extending in the front-rear direction on the protruding end of each tank tube 115.

The communication openings 119 are positioned in the sloped surface 104A each on the inside of the corresponding annular wall 122. The communication openings 119 penetrate the top wall 104 in the up-down direction. Each communication opening 119 has a semi-circular shape on the front side and a rectangular shape on the rear side. In other words, each communication opening 119 has a quadrilateral shape with its front side expanding forward to provide an arcuate shape. The communication openings 119 provide communication between the exterior and interior of the respective ink chambers 111A, 111B, 111C, and 111D. Each communication opening 119 is positioned frontward of the corresponding tank tube 115. Each communication opening 119 is also positioned below the corresponding tank tube 115. In other words, when viewed in the extending direction, a center of the communication opening 119 is positioned forward of the axial center of the corresponding tank tube 115.

The communication opening 119 is also positioned forward of the axial center of the annular wall 122. In other words, when viewed in the extending direction, the center of the communication opening 119 is positioned forward of the axial center of the annular wall 122. The communication openings 119 are an example of an injection opening of the disclosure.

As illustrated in FIG. 4, the tank cover 110 holds the ink tank 100 while covering the ink tank 100 from its front side. The tank cover 110 includes a front wall 201, a top wall 202, a right wall 203, a left wall 204, a bottom wall 205, and a sloped wall 206. The front wall 201 covers a front end of the ink tank 100. The front wall 201 has an opening 207 through which a part of the front wall 101 of the ink tank 100 is exposed toward the front side of the tank cover 110. Here, “a part of the front wall 101 of the ink tank 100 is exposed toward the front side of the tank cover 110 through the opening 207” means that that a user can see at least a portion of the front wall 101 from the front side of the tank cover 110 through the opening 207, and does not mean that a portion of the front wall 101 protrudes toward the front side from the tank cover 110 through the opening 207.

The tank cover 110 may further include a translucent cover that covers the opening 207 such that the front wall 101 of the ink tank 100 is visible from the front side of the tank cover 110. In this variation, the translucent cover may have the four upper marks 181 and the four lower marks 182. In other words, the upper marks 181 and the lower marks 182 may be provided on the tank cover 110, rather than the ink tank 100.

The top wall 202 covers a part of a front end portion of the top wall 104 constituting the ink tank 100. The right wall 203 covers a portion of the right wall 102 constituting the ink tank 100. The left wall 204 covers a portion of the left wall 103 constituting the ink tank 100. The bottom wall 205 covers the bottom wall 105 of the ink tank 100 from below.

The sloped wall 206 is connected to an upper end of the front wall 201 and a front end of the top wall 202. The sloped wall 206 is positioned above the respective annular walls 122 of the ink tank 100. The sloped wall 206 is also positioned forward of the respective annular walls 122 of the ink tank 100. In other words, the sloped wall 206 is positioned further in the extending direction relative to the annular walls 122. The sloped wall 206 has an outer surface extending to cross both the direction of gravity and the horizontal direction. The outer surface of the sloped wall 206 is sloped relative to the front-rear direction to extend diagonally downward toward the front. The sloped wall 206 covers a part of the sloped surface 104A of the top wall 104 constituting the ink tank 100.

The sloped wall 206 has four through-holes 72 arranged at intervals in the left-right direction. Each through-hole 72 penetrates the sloped wall 206 in the up-down direction. Each through-hole 72 is defined by a tubular-shaped inner circumferential surface that extends in a direction orthogonal to the outer surface of the sloped wall 206, i.e., diagonally upward and forward. In other words, each through-hole 72 is cylindrical in shape. Here, a “cylindrical shape” denotes a shape having a space therein enclosed by the inner circumferential surface, but the space defined by the inner circumferential surface need not be circular. Further, the through-hole 72 is cylindrical in shape, regardless of a length of the inner circumferential surface in an extending direction thereof, i.e., regardless of the thickness of the through-hole 72.

The inner circumferential surface defining each through-hole 72 surrounds the corresponding annular wall 122 when viewed from a viewpoint obliquely upward and forward therefrom. The four through-holes 72 are formed at positions corresponding to the four ink chambers 111A, 111B, 111C, and 111D, respectively. That is, the four through-holes 72 are positioned to overlap the respective four ink chambers 111A, 111B, 111C, and 111D when viewed from a viewpoint obliquely upward and forward therefrom. Each annular wall 122 and its corresponding communication opening 119 are both exposed to the outside the tank cover 110 through the corresponding through-hole 72. As illustrated in FIG. 6, each tank tube 115 protrudes out of the tank cover 110 through the corresponding through-hole 72. Through each through-hole 72, the corresponding tank tube 115 and communication openings 119 are visible. The through-holes 72 are so shaped that bottle caps 82 of respective ink bottles 80 can be inserted in the respective through-holes 72.

As illustrated in FIG. 6, each tank cap 127 is detachably mounted on the corresponding annular wall 122. The tank caps 127 are generally cylindrical with a closed end. When detached from the annular walls 122, the tank caps 127 are no longer connected to the ink tank 100 and tank cover 110 and are completely separated from the ink tank 100 and tank cover 110. In other words, the ink tank set 51 does not include any holding members, such as arms, for holding the tank caps 127 that has detached from the annular walls 122 to keep the detached tank caps 127 connected to the ink tank 100 or to the tank cover 110.

### [Positional Relationship Between the Ink Tank 100 and the Recording Head 39]

As illustrated in FIG. 3, the recording head 39 is positioned rearward of the rear wall 106 of the ink tank 100 in the front-rear direction. At the standby position P1, the recording head 39 is positioned leftward of the ink tank 100 in the left-right direction.

### [Ink Bottle 80]

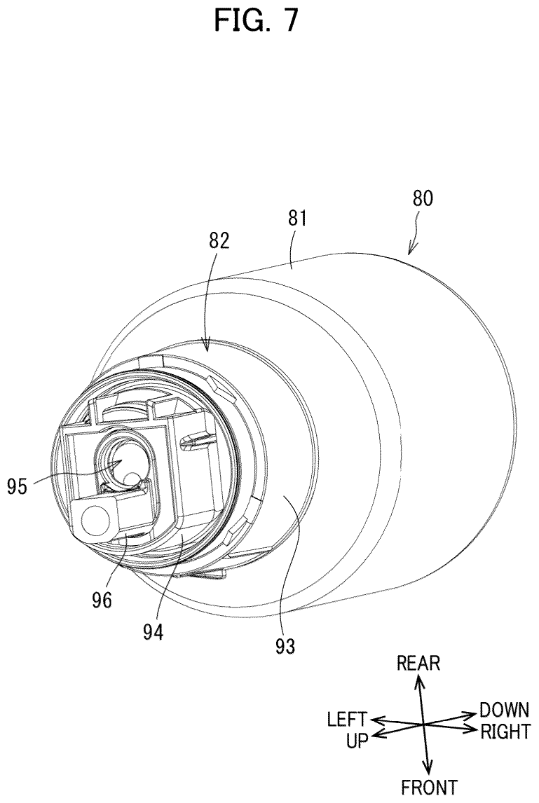

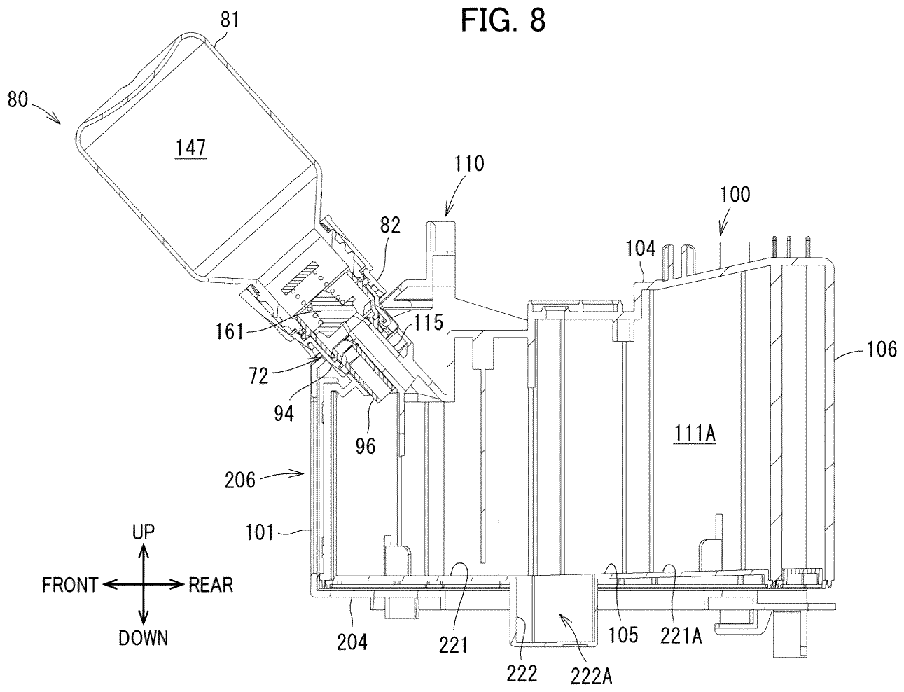

FIGS. 7 and 8 illustrate an ink bottle 80 that is connectable to the ink tank set 51. The ink bottle 80 includes a bottle body 81, a bottle cap 82, and a valve 161. The bottle body 81 is cylindrical in shape and is open on an upper end thereof. The bottle body 81 has an ink storage chamber 147 storing ink therein. The bottle cap 82 has a generally cylindrical shape and is detachably attachable to the open upper end of the bottle body 81. In a state where the bottle cap 82 is attached to the bottle body 81, an interior space in the bottle cap 82 is communication with the ink storage chamber 147.

The bottle cap 82 has a cap body 93, a protrusion 94, an opening 95, and a bottle tube 96. As illustrated in FIG. 7, the cap body 93 has a generally cylindrical shape. The protrusion 94 is constituted by a generally cylindrical-shaped wall extending upward from a top end of the cap body 93. The protrusion 94 can be inserted into the corresponding through-hole 72 in the tank cover 110. Hence, the protrusion 94 has an outer shape in conformance with the inner circumferential surface defining the corresponding through-hole 72. The opening 95 and the bottle tube 96 are positioned on a top end (protruding end) of the protrusion 94. The opening 95 provides communication between the interior and exterior of the ink bottle 80 when the bottle cap 82 is attached to the bottle body 81. As illustrated in FIG. 7, the bottle tube 96 is positioned forward of the opening 95. The bottle tube 96 protrudes farther upward than the top end of the cap body 93 of the bottle cap 82. The bottle tube 96 provides communication between the interior and exterior of the ink bottle 80 when the bottle cap 82 is attached to the bottle body 81.

As illustrated in FIG. 8, the valve 161 is located in an interior space defined in the cap body 93 of the bottle cap 82. The valve 161 normally closes the opening 95 and an opening of the bottle tube 96 on a side closer to the ink storage chamber 147. The valve 161 is movable in a direction (which is coincident with the up-down direction in FIG. 7) between a closed position and an open position. In the closed position, the valve 161 closes the opening 95 and the opening of the bottle tube 96 on the ink storage chamber 147 side. In the open position, the valve 161 opens the opening 95 and the opening of the bottle tube 96 on the ink storage chamber 147 side (see FIG. 8).

### [Connection Between the Ink Bottle 80 and the Ink Tank 100]

FIG. 8 illustrates a state where the ink bottle 80 is connected to the ink chamber 111A as an example of a connection of the ink bottle 80 to the ink tank 100.

First, the user inserts the protrusion 94 of the ink bottle 80 into the corresponding through-hole 72 of the tank cover 110. At this time, the bottle tube 96 of the ink bottle 80 is inserted into the corresponding communication opening 119 of the ink tank 100, whereas the tank tube 115 corresponding to the ink chamber 111A of the ink tank 100 is inserted into the opening 95 of the ink bottle 80. The tank tube 115 inserted in the opening 95 then moves the valve 161 from the closed position to the open position, thereby completing the connection of the ink bottle 80 to the ink tank 100.

When the ink bottle 80 is connected to the ink tank 100, the ink stored in the ink storage chamber 147 flows into the ink chamber 111A of the ink tank 100 through the bottle tube 96. At the same time, air in the ink tank 100 flows into the ink storage chamber 147 of the ink bottle 80 through the tank tube 115. In this way, the ink in the ink bottle 80 is supplied into the ink chamber 111A utilizing the so-called gas-liquid replacement.

### Operational and Technical Advantages of the Embodiment

In the ink tank 100 according to the embodiment, the outlets 114 are positioned in the respective spaces 222A defined by the wall surfaces 222 (protruding chamber 222) protruding downward from the bottom wall 105 that constitutes the bottom of the respective ink chambers 111A, 111B, 111C, and 111D. With this arrangement, the ink stored in the respective ink chambers 111A, 111B, 111C, and 111D of the ink tank 100 is easier to be used up in the multifunction peripheral 10. Further, since the bottom wall 105 is connected in a liquid-tight manner to the wall structure 511 which is an integrally molded product with the front wall 101, right wall 102, left wall 103, top wall 104, rear wall 106, and four partition walls 131, 132, 133, and 134 integrally molded altogether as a single unit, there is less need to use a film to define defining the four ink chambers 111A, 111B, 111C, and 111D arranged in a lateral direction crossing the up-down direction. Therefore, it is easier to ensure not only the volumetric accuracy of the ink chambers 111A, 111B, 111C, and 111D but also the strength of the ink tank 100 in the lateral direction crossing the up-down direction.

Since the bottom wall 105 is also a molded product that is manufactured in the same resin material as the integrally-molded wall structure 511, the ink tank 100 does not use a film as surfaces for defining the respective ink chambers 111A, 111B, 111C, and 111D. Accordingly, there is no risk that a film may be damaged or broken in the ink tank 100.

In the ink tank 100 of the embodiment, the bottom wall 105 is connected to the integrally-molded wall structure 511 in a liquid-tight manner, thereby ensuring a more reliable liquid-tight seal with the wall structure 511.

In the ink tank 100 of the embodiment, the four lower marks 182 are positioned above the bottom edge of the front surface 101B. Hence, the bottom wall 105 is liquid-tightly connected to the integrally-molded wall structure 511 at a position below and apart from the lower marks 182. This arrangement can reduce any discrepancies in distance between the four upper marks 181 and the four lower marks 182, thereby ensuring better positional accuracy of the upper marks 181 and lower marks 182 than if the bottom wall 105 were connected at a position between the upper marks 181 and lower marks 182 in the up-down direction.

In the ink tank 100 of the embodiment, the communication openings 119 are formed in the top wall 104 constituting the integrally-molded wall structure 511. This configuration ensures an improved strength of the walls defining each of the ink chambers 111A, 111B, 111C, and 111D, compared to a structure where the communication openings 119 are formed in a top wall that is connected liquid-tightly to an integrally-molded wall structure without a top wall. Further, in the walls defining the ink chambers 111A, 111B, 111C, and 111D of the ink tank 100, less strength is required in areas below the lower marks 182 than in areas above the upper marks 181. Thus, the walls defining the ink chambers 111A, 111B, 111C, and 111D in this embodiment can have greater strength than if the bottom wall 105 were connected in a liquid-tight manner to the integrally-molded wall structure 511 at a position above the four lower marks 182.

In the ink tank 100 of the embodiment, each outlet 114 is positioned in the corresponding space 222A (protruding chamber 222) such that the outlet 114 is spaced apart from each wall surface 222 defining the space 222A. Accordingly, ink bubbles deposited on the wall surfaces 222 are less likely to enter inside the outflow channel 150 through the outlet 114.

In the ink tank 100 of the embodiment, the ink in the ink chambers 111A, 111B, 111C, and 111D flows to the recording head 39 through the respective outflow tubes 124 connected to the respective openings 113 in the top wall 104. Therefore, the outflow channel 150 can be made shorter in length than if the outflow channel 150 were to extend in a horizontal direction from the outlet 114 and subsequently to extend upward along the outer surface of the ink tank 100. That is, in the ink tank 100 of the embodiment, the outflow channel 150 need not be defined by a film affixed to the outer surface of the ink tank 100. Accordingly, ink leakage attributed to breakage of a film is unlikely to occur. Further, this configuration can also ensure the strength of the ink tank 100 more easily than otherwise, since no damage to a film is conceivable.

In each outflow tube 124 in the ink tank 100 of the embodiment, the cross-sectional area S1 in the small-diameter portion 124A is smaller than the cross-sectional area S2 in the large-diameter portion 124B. With this configuration, the mold for molding the wall structure 511 can be easily pulled out from the wall structure 511 after all the walls constituting the wall structure 511 (the front wall 101, right wall 102, left wall 103, top wall 104, rear wall 106, and partition walls 131, 132, 133, and 134) have been integrally molded as a single unit. Further, ink bubbles are less likely to flow into the respective outflow tubes 124 through the outlets 114.

In the ink tank 100 of the embodiment, the top surface 105A of the bottom wall 105 has the sloped surface 221A that extends rearward from the corresponding space 222A (protruding chamber 222) in each ink chamber 111A, 111B, 111C, 111D. The sloped surface 221A slopes relative to the front-rear direction to extend diagonally downward and frontward toward the corresponding space 222A (protruding chamber 222) in each ink chamber 111A, 111B, 111C, 111D. With this structure, the ink stored in the respective ink chambers 111A, 111B, 111C, and 111D can readily flow to the respective spaces 222A (protruding chamber 222) along the respective sloped surfaces 221A, thereby facilitating using up of the ink in respective ink chambers 111A, 111B, 111C, and 111D.

In the ink tank 100 of the embodiment, the four ink chambers 111A, 111B, 111C, and 111D are partitioned in the left-right direction from one another by the three partition walls 131, 132, and 133. Accordingly, the ink tank 100 can be made more compact than if the four ink chambers 111A, 111B, 111C, and 111D were arranged to be spaced apart from one another other in the left-right direction.

In the ink tank 100 of the embodiment, the light-emitting element 311A is covered by the silicone front cover 227, and the light-receiving element 311B is covered by the silicone rear cover 228. With this structure, the ink in the ink chamber 111D is less likely to remain on the optical path of the light emitted from the light-emitting element 311A toward the light-receiving element 311B when the level of the ink in the ink chamber 111D drops to a lower level, resulting in high detection accuracy of the sensor 311.

In the ink tank 100 of the embodiment, the user can insert the light-emitting element 311A and light-receiving element 311B into the front accommodating space 225A and rear accommodating space 226A, respectively, from below. Assembly of the light-emitting element 311A and light-receiving element 311B to the bottom wall 105 can be easily performed.

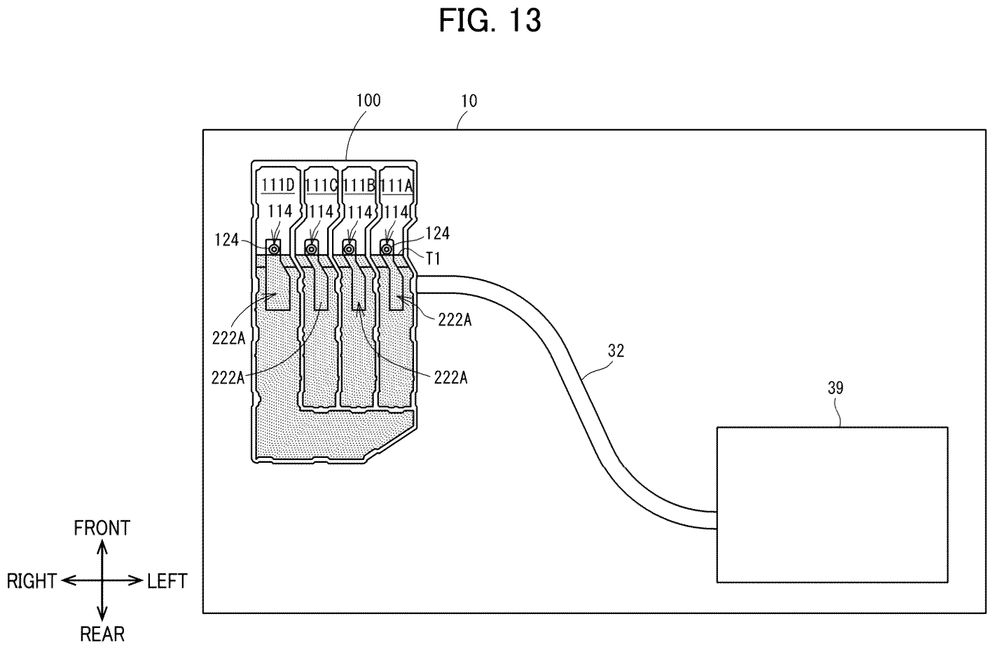

During transportation of the multifunction peripheral 10 for shipment, the multifunction peripheral 10 may be placed in such an orientation that the rear end of the multifunction peripheral 10 faces downward, as illustrated in FIG. 13, for example, to make effective use of space. In this orientation, since the recording head 39 is positioned lower than the ink tank 100, the ink in the respective ink chambers 111A, 111B, 111C, and 111D is likely to flow to the recording head 39 through the outlets 114 of the respective outflow tubes 124, possibly resulting in leakage of the ink from the recording head 39. However, when the multifunction peripheral 10 of the embodiment is placed in this orientation, the outlets 114 are positioned forward of the front-rear centers of the respective ink chambers 111A, 111B, 111C, and 111D, meaning that the outlets 114 is likely to be positioned above a level T1 of the ink stored in the respective ink chambers 111A, 111B, 111C, and 111D. Accordingly, the ink in the respective ink chambers 111A, 111B, 111C, and 111D is less likely to flow to the recording head 39 through the outlets 114, thereby suppressing the leakage of ink from the recording head 39.

In the ink tank 100 of the embodiment, each outlet 114 is positioned forward of the front-rear center of the corresponding protruding space 222A. With this structure, since a smaller clearance is formed between each outlet 114 and the wall surface 222 defining the front end of the protruding space 222A, ink bubbles are less likely to enter the clearance even when the multifunction peripheral 10 is placed in the orientation with its rear side facing downward. Even if ink bubbles may be deposited on the outlet 114, the bubbles tend to drop off the outlet 114.

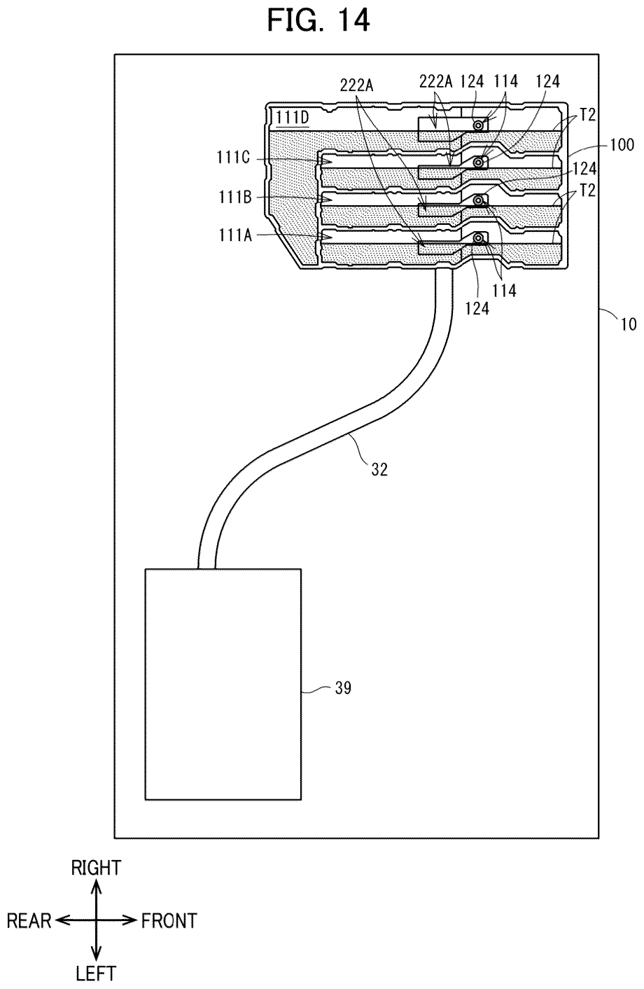

Alternatively, during transportation of the multifunction peripheral 10 for shipment, the multifunction peripheral 10 may be placed in an orientation with its left side facing downward, as illustrated in FIG. 14, in order to make effective use of space. In this case, the recording head 39 is positioned lower than the ink tank 100. Consequently, the ink in the respective ink chambers 111A, 111B, 111C, and 111D may easily flow to the recording head 39 through the outlets 114 of the respective outflow tubes 124, possibly causing ink leakage from the recording head 39. However, in the multifunction peripheral 10 of the embodiment, the outlets 114 are positioned rightward of the left-right centers A2, A4, A6, and A8 of the respective ink chambers 111A, 111B, 111C, and 111D when the multifunction peripheral 10 is placed in the orientation with its left side facing downward, as illustrated in FIG. 14. Hence, the outlets 114 are likely to be positioned above a level T2 of the ink stored in the ink chambers 111A, 111B, 111C, and 111D, meaning that the ink in the ink chambers 111A, 111B, 111C, and 111D is less likely to flow to the recording head 39 through the respective outlets 114. Thus, this configuration can suppress ink leakage from the recording head 39.

### Variations and Modifications

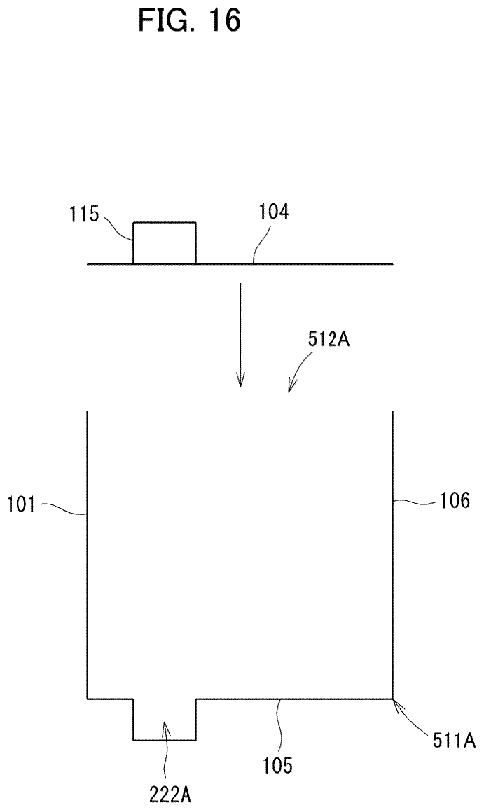

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below: In the ink tank 100 of the above-described embodiment, the front wall 101, right wall 102, left wall 103, top wall 104, rear wall 106, and four partition walls 131, 132, 133, and 134 are integrally molded together to constitute the wall structure 511. Alternatively, the wall structure 511 may be provided as an integrally molded product (a single unit) configured of the front wall 101, right wall 102, left wall 103, bottom wall 105, rear wall 106, and four partition walls 131, 132, 133, and 134 (for example, see a wall structure 511A depicted in FIG. 16). In this case, the top wall 104 is connected in a liquid-tight manner to top edges of the integrally-molded wall structure 511A to cover an aperture 512A in the wall structure 511A.

In the ink tank 100 of the above-described embodiment, the bottom wall 105 is welded to the wall structure 511 which is an integrally-molded product configured of the front wall 101, right wall 102, left wall 103, top wall 104, rear wall 106, and partition walls 131, 132, 133, and 134. However, the bottom wall 105 need not be welded to the integrally-molded wall structure 511, provided that the bottom wall 105 can be connected to the wall structure 511 in a liquid-tight manner. For example, the bottom wall 105 may be made of rubber or resin having flexibility, and may be press-fitted in the aperture 512 of the wall structure 511 to provide liquid-tight connection to the wall structure 511. Still alternatively, the bottom wall 105 may be liquid-tightly connected to the integrally-molded wall structure 511 by applying a tape to an area of connection between the bottom wall 105 and wall structure 511.

In the ink tank 100 of the above-described embodiment, an opening(s) may be formed in at least one of the front wall 101, right wall 102, left wall 103, rear wall 106, and four partition walls 131, 132, 133, and 134. In this case, a film(s) may be welded over the opening(s) to cover the same.

In the ink tank 100 of the above-described embodiment, the bottom wall 105 is welded to the wall structure 511 at a position below and separated from the four lower marks 182. However, the bottom wall 105 may be welded to the integrally-molded wall structure 511 at a position between the lower marks 182 and the upper marks 181 in the up-down direction, for example. Further, as illustrated in FIG. 16, if the bottom wall 105 is integrally molded together with peripheral walls, such as the front wall 101 and rear wall 106, to constitute the integrally-molded wall structure 511A as a single unit, the top wall 104 may be welded to this integrally-molded wall structure 511A. In this case, the top wall 104 may be welded to the wall structure 511A at a position above and separated from the upper marks 181 or at a position between the lower marks 182 and upper marks 181 in the up-down direction.

In the ink tank 100 of the embodiment, each outlet 114 is positioned in the corresponding protruding space 222A such that the outlet 114 is spaced apart from the wall surfaces 222 defining the protruding space 222A. However, each outlet 114 may be arranged to contact at least one of the wall surfaces 222 inside the corresponding protruding space 222A, as long as ink can flow through the outlet 114 within the corresponding protruding space 222A.

In the ink tank 100 of the above embodiment, each outflow tube 124 extends downward from the corresponding opening 113 formed in the top wall 104. Alternatively, the outflow tube 124 may extend upward from an opening formed in the bottom wall 105, for example.

In the ink tank 100 of the embodiment, the small-diameter portion 124A of each outflow tube 124 has a smaller inner diameter than the large-diameter portion 124B of each outflow tube 124. Alternatively, each outflow tube 124 may be formed to have a constant inner dimeter from the corresponding outlet 114 to the corresponding opening 113, for example. In other words, the outflow channel 150 may have a constant cross-sectional area taken along a horizontal plane from the outlet 114 to the opening 113.

In the ink tank 100 of the embodiment, the sloped surface 221A constituting a part of the top surface 105A of the bottom wall 105 slopes relative to the front-rear direction. However, the sloped surface 221A may be parallel to a horizontal plane, for example.

In the ink tank 100 of the embodiment, the four ink chambers 111A, 111B, 111C, and 111D are arranged to be adjacent to one another in the left-right direction, with the four ink chambers 111A, 111B, 111C, and 111D partitioned by the three partition walls 131, 132, and 133. However, the ink chambers 111A, 111B, 111C, and 111D may be arranged to be spaced apart from one another in the left-right direction.

In the ink tank 100 of the embodiment, the light-emitting element 311A of the sensor 311 is covered by the front cover 227 made of silicone. However, the light-emitting element 311A may be covered by a front cover formed of a material other than silicone, provided that the material can transmit light. Further, the light-emitting element 311A may not be covered by the front cover 227. Similarly, the light-receiving element 311B of the sensor 311 may be covered by a rear cover that is formed of a material other than silicone, provided that the material can transmit light. Further, the light-receiving element 311B may not be covered by the rear cover 228.

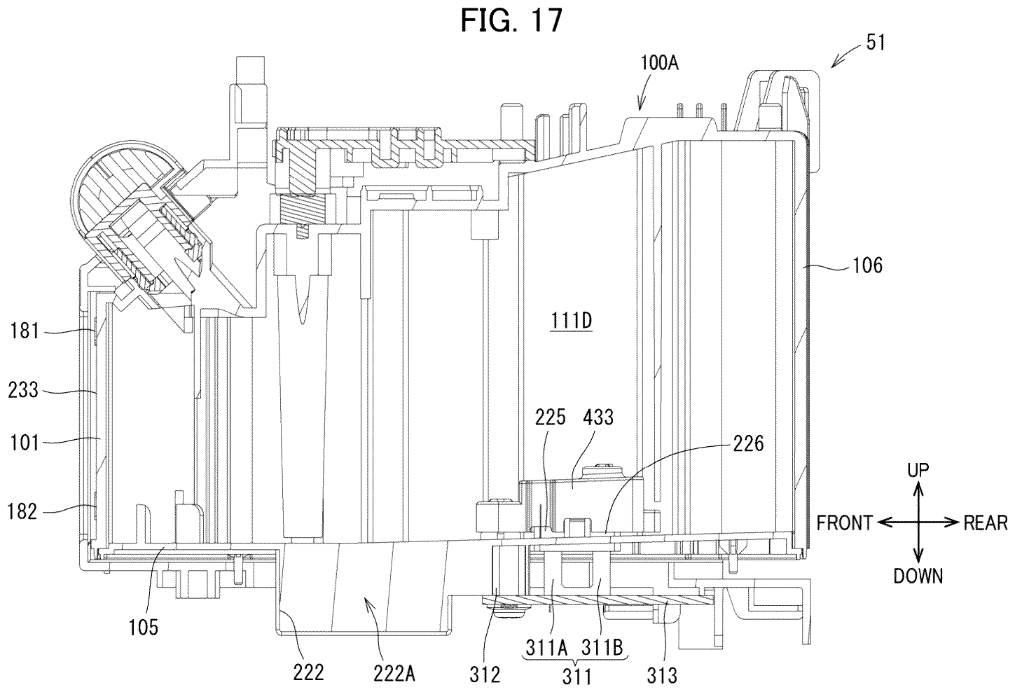

If the front cover 227 and rear cover 228 are omitted, the light-emitting element 311A and light-receiving element 311B may be covered by a light-shielding member 433 that can block light, as illustrated in FIG. 17. Specifically, in this ink tank 100A according to a modification of the embodiment, the light-shielding member 433 has a box shape that is open toward the bottom. The front accommodating part 225 and rear accommodating part 226 are both arranged in an internal space of the box-shaped light-shielding member 433. The light-shielding member 433 is formed of rubber, and is mounted over the front accommodating part 225 and rear accommodating part 226 to cover outer surfaces of the same by being elastically deformed to expand its internal space. Since the light-shielding member 433 can block the light emitted from the light-emitting element 311A, the user is unlikely to perceive the traveling light through the corresponding viewing surface 233. The light-shielding member 433 is an example of a light-shielding member of the disclosure.

Incidentally, the light-shielding member 433 may be mounted on the bottom wall 105 by thermal caulking while covering the front accommodating part 225 and the rear accommodating part 226. Still alternatively, in place of the light-emitting element 311A and light-receiving element 311B, an electrode may be provided at a position to be detected by the sensor 311. In this case, the electrode may be covered by the light-shielding member 433.

In a case where the ink used in the ink chambers 111A, 111B, 111C, and 111D is pigment-based ink, which has a higher viscosity than dye-based ink, conceivably, the ink may be likely to remain on the optical path of the light irradiated from the light-emitting element 311A toward the light-receiving element 311B. For this reason, preferably, the light-emitting element 311A and light-receiving element 311B be covered by the silicone front cover 227 and silicone rear cover 228, respectively. When pigment-based ink is employed, infrared light, which is invisible to people, can be used as the light to be emitted from the light-emitting element 311A. Hence, the user will not perceive the emitted light when looking through the viewing surfaces 233.

On the other hand, in a case where the ink used in the ink chambers 111A, 111B, 111C, and 111D is dye-based ink, the ink is less likely to remain on the optical path of the light emitted from the light-emitting element 311A toward the light-receiving element 311B since dye-based ink has a lower viscosity than pigment-based ink. However, invisible light cannot be used as the light emitted from the light-emitting element 311A when dye-based ink is employed, which requires the use of visible light. As such, in this case, preferably, the light-emitting element 311A and light-receiving element 311B be covered with the light-shielding member 433, so that the user would not perceive the light emitted from the light-emitting element 311A through the viewing surfaces 233.

In the ink tank 100 of the embodiment, the light-emitting element 311A and light-receiving element 311B of the sensor 311 are assembled to the bottom wall 105 by being inserted into the respective front accommodating space 225A and rear accommodating space 226A from below the bottom wall 105. However, there is no particular restriction on the method of assembling the light-emitting element 311A and light-receiving element 311B to the bottom wall 105, provided that the light-emitting element 311A and light-receiving element 311B can detect the level of ink stored in the ink chamber 111D. For example, the front accommodating part 225 and rear accommodating part 226 may be formed to be open upward on the top surface 105A of the bottom wall 105; and the light-emitting element 311A and light-receiving element 311B may be inserted, from above, into the front accommodating space 225A defined by the front accommodating part 225 and into the rear accommodating space 226A defined by the rear accommodating part 226, respectively, for assembly of the sensor 311 to the bottom wall 105. In this case, a cover member may be provided for closing the upper openings in the respective front accommodating part 225 and rear accommodating part 226.

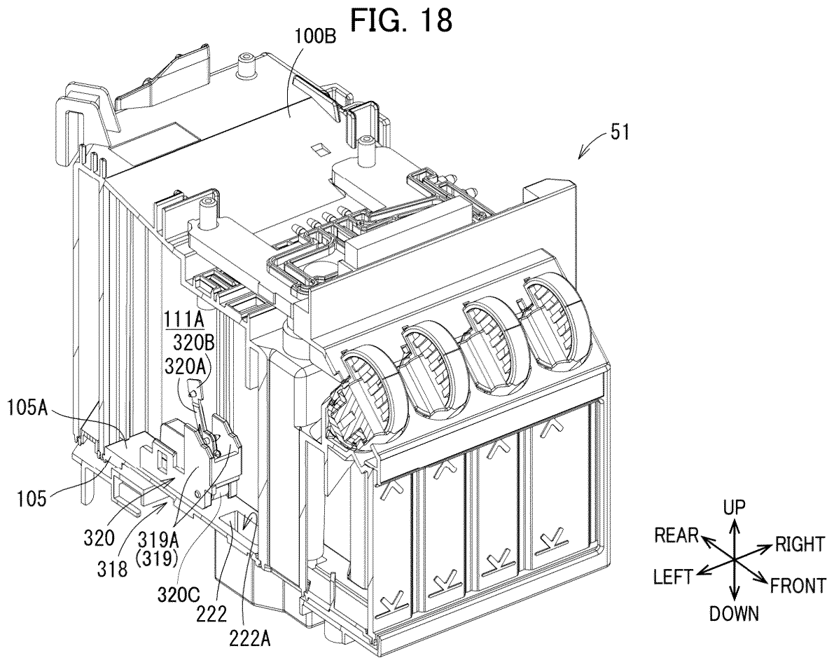

In the ink tank 100 of the embodiment, the front accommodating part 225 and rear accommodating part 226 are positioned rearward of the offset chamber 141D. However, the front accommodating part 225 and rear accommodating part 226 may not be provided. In this case, as illustrated in FIG. 18, a sensor 318 may be provided in the ink chamber 111A in place of the sensor 311 in the ink chamber 111D.

In an ink tank 100B according to this modification illustrated in FIG. 18, the sensor 318 includes a light-emitting element configured to emit light, a light-receiving element configured to receive the light from the light-emitting element, a support member 319, and a pivoting member 320. The support member 319 is disposed on the top surface 105A of the bottom wall 105. Note that the light-emitting element and light-receiving element are not illustrated in FIG. 18. The support member 319 has two opposing walls 319A that oppose each other in the left-right direction. The pivoting member 320 includes an arm 320A pivotably supported by the opposing walls 319A, a detection part 320B positioned on a free end of the arm 320A, and a float 320C positioned on a base end of the arm 320A. The arm 320A is pivotable due to the buoyancy of the float 320C, which is generated according to the residual quantity of the ink in the ink chamber 111A. The arm 320A is configured to pivot such that the detection part 320B is at its highest position when the ink in the ink chamber 111A comes to the detection position of the sensor 318. The light-emitting element and light-receiving element are positioned such that the detection part 320B is interposed between the light-emitting element and the light-receiving element in the left-right direction when the detection part 320B is at its highest position. When the detection part 320B is at its highest position, the light-receiving element cannot receive the light emitted from the light emitting element, because the emitted light is blocked by the detection part 320B. When the detection part 320B is at a position lower than the highest position, the light-receiving element receives the light emitted from the light-emitting element. With this structure, since the light-emitting element and light-receiving element can be arranged at positions higher than the detection position of the sensor 318, the space around the detection position in the ink chamber 111A can be effectively utilized. Note that the sensor 318 may be provided in one or more of the ink chambers 111A, 111B, 111C, and 111D. The sensor 318 is another example of the sensor of the disclosure.

In the ink tank 100 of the embodiment, the outlets 114 are positioned forward of the front-rear centers of the respective ink chambers 111A, 111B, 111C, and 111D. However, the respective outlets 114 may be arranged at suitable positions, as long as the outlets 114 are located within the respective protruding spaces 222A. For example, the outlets 114 may be arranged at the front-rear centers of the respective ink chambers 111A, 111B, 111C, and 111D. In this case, the wall surfaces 222 defining each protruding space 222A (protruding chamber 222) may be arranged at the front-rear center of the corresponding ink chamber 111A, 111B, 111C, 111D.

In the ink tank 100 of the embodiment, each outlet 114 is positioned forward of the front-rear center of the corresponding protruding space 222A. However, the position of each outlet 114 needs not be limited, provided that the outlet 114 is positioned in the corresponding protruding space 222A. For example, each outlet 114 may be positioned at the front-rear center of the corresponding protruding space 222A.

In the ink tank 100 of the embodiment, each outlet 114 is positioned offset toward the right from the left-right center of the corresponding ink chamber 111A, 111B, 111C, 111D. However, the position of each outlet 114 needs not be limited, provided that the outlet 114 is positioned in the corresponding protruding space 222A. For example, each outlet 114 may be positioned at the left-right center of the corresponding ink chamber 111A, 111B, 111C, 111D. In this case, the offset chambers 141A, 141B, 141C, and 141D are omitted from the respective ink chambers 111A, 111B, 111C, and 111D.

In the ink tank 100 of the embodiment, the communication openings 119 are provided in the sloped surface 104A of the top wall 104. However, the communication openings 119 may be provided in a horizontal surface constituting the top wall 104, for example. In this case, the top wall 104 need not have the sloped surface 104A.

In the ink tank 100 of the embodiment, the top surface 105A of the bottom wall 105 includes wall surfaces 222 that are recessed downward from the flat surface 221. However, the wall surfaces 222 may be omitted. Still alternatively, the bottom wall 105 may be configured by a film. Even in this case, volumetric accuracy of the ink chambers 111A, 111B, 111C, and 111D can be reliably ensured, since the film attached to the bottom wall 105 is less likely to deform than if a film is used to define the top end or any lateral end of each ink chamber 111A, 111B, 111C, 111D, the lateral ends being ends of each ink chamber 111A, 111B, 111C, 111D in a horizontal direction crossing the up-down direction.

What is claimed is:

1. A tank comprising:
a storage chamber for storing liquid therein;
a bottom wall extending in a lateral direction crossing an up-down direction, the bottom wall having an inner surface including:
a flat part extending in the lateral direction and defining a bottom of the storage chamber; and
a protruding part protruding downward from the flat part and defining an extra space in communication with the storage chamber;
a top wall positioned above the bottom wall and extending in the lateral direction;
a peripheral wall extending in the up-down direction and connecting the bottom wall to the top wall; and
an outlet for discharging the liquid in the storage chamber, the outlet being positioned in the extra space,
wherein either one of the bottom wall and the top wall is integrally molded with the peripheral wall to constitute an integrally-molded wall structure having an aperture, and a remaining one of the bottom wall and the top wall is liquid-tightly connected to the integrally-molded wall structure while covering the aperture to define the storage chamber.

2. The tank according to claim 1,
wherein the remaining one of the bottom wall and the top wall is liquid-tightly welded to the integrally-molded wall structure.

3. The tank according to claim 1,
wherein the peripheral wall includes a front wall defining a front end of the storage chamber, the front wall having:
a first mark indicative of a first level of the liquid in the storage chamber in the up-down direction; and
a second mark indicative of a second level of the liquid in the storage chamber in the up-down direction, the second level being lower than the first level, and
wherein the remaining one of the bottom wall and the top wall is liquid-tightly connected to the integrally-molded wall structure at a position outside of a region between the first mark and the second mark in the up-down direction.

4. The tank according to claim 3,
wherein the top wall is integrally molded with the peripheral wall to constitute the integrally-molded wall structure,
wherein the integrally-molded wall structure has an injection opening through which liquid is to be introduced into the storage chamber, and
wherein the bottom wall is liquid-tightly connected to the integrally-molded wall structure.

5. The tank according to claim 4,
wherein the bottom wall is liquid-tightly connected to the integrally-molded wall structure at a position below the second mark in the up-down direction.

6. The tank according to claim 1,
wherein the outlet is positioned in the extra space such that the outlet is spaced apart from the protruding part of the inner surface defining the extra space.

7. The tank according to claim 6,
wherein the top wall has a through-hole penetrating therethrough,
the tank further comprising:
an outflow tube extending in the up-down direction and having a bottom end in which the outlet is formed, the outflow tube defining therein an outflow channel in communication with the storage chamber through the outlet, the outflow channel being in communication with the through-hole to allow the liquid to flow from the storage chamber to an outside of the tank through the outlet and the through-hole.

8. The tank according to claim 7,
wherein the outflow tube has an upper portion and a lower portion in the up-down direction, and
wherein the outflow channel has a cross-sectional area taken along a horizontal plane in the lower portion that is smaller than a cross-sectional area taken along a horizontal plane in the upper portion.

9. The tank according to claim 1,
wherein the inner surface of the bottom wall further includes a sloped part connected to the protruding part, the sloped part sloping relative to a direction orthogonal to the up-down direction such that the sloped part extends diagonally downward toward the extra space.

10. The tank according to claim 1, further comprising a second storage chamber for storing liquid therein,
wherein the peripheral wall includes a partition wall partitioning the second storage chamber from the storage chamber in a left-right direction orthogonal to the up-down direction.

11. The tank according to claim 1, further comprising a sensor configured to detect a level of the liquid stored in the storage chamber, the sensor comprising:
a light-emitting element configured to emit light; and
a light-receiving element configured to output a first signal when not receiving the light from the light-emitting element and output a second signal when receiving the light from the light-emitting element,
wherein the light-emitting element is covered by a first cover made of silicone, and
wherein the light-receiving element is covered by a second cover made of silicone.

12. The tank according to claim 11,
wherein the bottom wall has:
a first accommodating part that is recessed upward toward the storage chamber and that is open on an outer surface of the bottom wall, the first accommodating part defining therein a first accommodation space in which the light-emitting element is accommodated; and
a second accommodating part opposing the first accommodating part, the second accommodating part being recessed upward toward the storage chamber and being open on the outer surface of the bottom wall, the second accommodating part defining therein a second accommodation space in which the light-receiving element is accommodated,
wherein the first cover covers the first accommodating part in the storage chamber, and
wherein the second cover covers the second accommodating part in the storage chamber.

13. The tank according to claim 1, further comprising a sensor configured to detect a level of the liquid stored in the storage chamber, the sensor comprising:
a pivoting member positioned inside the storage chamber;
a float provided at one end of the pivoting member; and
a detection part provided at another end of the pivoting member, the pivoting member being configured to pivot according to the level of the liquid in the storage chamber.

14. The tank according to claim 1, further comprising a sensor configured to detect a level of the liquid stored in the storage chamber, the sensor comprising:
a light-emitting element configured to emit light; and
a light-receiving element configured to output a first signal when not receiving the light from the light-emitting element and output a second signal when receiving the light from the light-emitting element,
wherein the peripheral wall includes a front wall defining a front end of the storage chamber, the front wall having a viewing surface through which the storage chamber is visible, and
wherein the light-emitting element and the light-receiving element are covered by a light-shielding member capable of shielding the light emitted from the light-emitting element.

15. A tank comprising:
a storage chamber for storing liquid therein;
a bottom wall;
a top wall opposing the bottom wall in an up-down direction and defining a top of the storage chamber, the top wall having a through-hole; and
an outflow tube positioned in the storage chamber and extending in the up-down direction to have an outlet at a bottom thereof, the outflow tube defining therein an outflow channel in communication with the storage chamber through the outlet, the outflow channel being in communication with an outside of the tank through the through-hole to allow the liquid in the storage chamber to flow to the outside of the tank through the outlet and the through-hole,
wherein the bottom wall has an inner surface including:
a flat part extending in a lateral direction crossing the up-down direction and defining a bottom of the storage chamber; and
a protruding part extending downward from the flat part and defining an extra space in communication with the storage chamber, the outlet being positioned in the extra space.

16. A tank comprising:
a storage chamber for storing liquid therein;
a top wall defining a top of the storage chamber in an up-down direction;
a bottom wall positioned below the top wall and defining a bottom of the storage chamber in the up-down direction;
a peripheral wall defining an end of the storage chamber in a lateral direction crossing the up-down direction; and
an injection opening penetrating the top wall to allow liquid to be introduced into the storage chamber,
wherein the top wall and the peripheral wall are integrally molded to constitute an integrally-molded wall structure, the bottom wall being liquid-tightly connected to the integrally-molded wall structure to define the storage chamber.

17. A liquid-consuming device comprising:
a housing;
the tank according to claim 1 positioned in an internal space of the housing; and
a head comprising a nozzle configured to eject the liquid supplied from the tank, the head being positioned rearward of the tank in the internal space of the housing in a front-rear direction orthogonal to the up-down direction, the outlet being positioned frontward of a center of the storage chamber in the front-rear direction.

18. The liquid-consuming device according to claim 17,
wherein the outlet is positioned frontward of a center of the extra space in the front-rear direction.

19. A liquid-consuming device comprising:
a housing;
the tank according to claim 1 positioned in an internal space of the housing at one side in a left-right direction orthogonal to the up-down direction; and
a head comprising a nozzle configured to eject the liquid supplied from the tank, the head being positioned in the internal space of the housing at an other side opposite the one side in the left-right direction, the outlet being positioned offset toward the one side from a center of the storage chamber in the left-right direction.
